(19) United States
(12) Patent Application Publication
(10) Pub. No.: US 2005/0188226 A1
(43) Pub. Date: Aug. 25, 2005

(54) Authentication method

(76) Inventor: Kiyoshi Kasatani, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/065,160

(22) Filed: Feb. 25, 2005

(30) Foreign Application Priority Data
Feb. 25, 2004 (JP) 2004-049186

(51) Int. Cl. H04L 9/00

(52) U.S. Cl. 713/201

(57) ABSTRACT

When fingerprint information is input by users to login from the fingerprint sensor, an authentication priority is set for each of the users based on login information of each of the users. The login information is stored in a login information table. Authentication of the users are carried out by comparing the fingerprint information input and fingerprint information of each finger of the users that are registered in a fingerprint information table in order based on the authentication priority from a user that has a highest ranking.

### CROSS-REFERENCE TO RELATED APPLICATIONS

The present document incorporates by reference the entire contents of Japanese priority document, 2004-049186 filed in Japan on Feb. 25, 2004.

### BACKGROUND OF THE INVENTION

1) Field of the Invention

The present invention relates to an authentication method for authenticating a user that is registered in a data processor.

2) Description of the Related Art

Recently, a network communication system that includes a network multifunction product has been built. The network multifunction product is connected to a network and applies various communication protocols, and enables various data communications with other terminal units.

In such a network communication system, various kinds of application services are provided using the network multifunction product as a core. For example, the application services include a “scan to e-mail” service in which an image scanned is transmitted to a specified e-mail address, an e-mail printout service in which text information in a received e-mail and an image in an attached file are recorded and output, and an e-mail facsimile transfer service in which text information in a received e-mail and an image in an attached file are transmitted to a specified facsimile machine. Such a technology is disclosed in, for example, Japanese Patent Application Laid-Open No. H9-284448.

For such network multifunction product, authentication of a user is necessary in view of security. The authentication is carried out, for example, to limit users that can use the network multifunction product, or to limit functions that each user can use, and is carried out by, for example, requiring a login operation, such as inputting a user ID and a password from an operation screen.

However, such login operation in which the user ID and the password are used to verify a user requires key operation by the user, and this makes a process complicated. In addition, it is necessary for the user to remember the user ID and the password that are registered. Therefore, an operation error may occur, and if the operation error occurs, recovery is difficult. Thus, in such authentication, there is a problem in the user-friendliness.

Therefore, a biological authentication system in which fingerprints of users are registered and used to verify the users in logon processing with a fingerprint sensor has been proposed.

However, in such a biological authentication system, when the fingerprints of more than one finger of users are registered, or when a great number of the users are registered, it takes time for obtaining an authentication result, thereby deteriorating convenience.

### SUMMARY OF THE INVENTION

It is an object of the present invention to solve at least the above problems in the conventional technology.

An authentication method for authenticating users according to one aspect of the present invention includes storing first fingerprint information of the users, wherein the first fingerprint information includes fingerprint information of at least one finger of each of the users; storing login information of each of the users; setting a priority for each of the users based on the login information when second fingerprint information is input by the users to login; and authenticating the users by comparing the first fingerprint information and the second fingerprint information. The authenticating includes authenticating the users in order based on the priority, from a user having a highest priority.

An apparatus for authentication of users according to another aspect of the present invention includes a fingerprint sensor for inputting first fingerprint information of the users, wherein the first fingerprint information includes fingerprint information of at least one finger of each of the users; a first memory that stores the first fingerprint information; and a second memory that stores login information of each of the users. When second fingerprint information is input by the users via the fingerprint sensor to login, a priority for each of the users are set based on the login information, and authentication of the users is carried out by comparing the first fingerprint information and the second fingerprint information in order based on the priority, from a user having a highest priority.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a system that includes a digital color multifunction product according to one embodiment of the present invention;

FIG. 2 is a perspective view of the digital color multifunction product;

FIG. 3 is a block diagram of the digital color multifunction product;

FIG. 4 is a plan view of an operation panel;

FIG. 5 is a block diagram of a processing module that operates in the digital color multifunction product;

FIG. 6 is a schematic of an information area that is registered in an information processing unit B of the digital color multifunction product;

FIG. 7A is a table of personal setting information;

FIG. 7B is a table of personal information;

FIG. 8A is a table of registration information;

FIG. 8B is a table of e-mail destination;

FIG. 8C is a table of a facsimile address;

FIG. 8D is a table of a group address;

FIG. 8E is a table of a file address;

FIG. 9A is a table of a network path;

FIG. 9B is a table of a local path of the file address;

FIG. 9C is a table of a title and contents;

FIG. 9D is a table of a document name and a user name;

FIG. 10A is a table of preset information;

FIG. 10B is a table of a read condition;

FIGS. 11A and 11B are tables of an image processing condition;

FIGS. 12A and 12B are tables of a transmission/storage condition one-touch;

FIG. 12B is a table of a transmission/storage condition one-touch;

FIG. 13 is a table of a print condition one-touch;

FIG. 14A is a table of an incoming mailbox;

FIG. 14B is a table of an initial value of a name;

FIG. 14C is a table of an initial value of an account name;

FIG. 14D is a table of a shared media address;

FIG. 14E is a table of a file transmission link address;

FIG. 15A is a table of personal system setting information;

FIG. 15B is a table of a standard setting;

FIG. 16 is a table of a display setting;

FIG. 17A is a table of a read setting;

FIG. 17B is a table of a communication setting;

FIG. 17C is a table of a storage setting;

FIG. 18A is a table of a print setting;

FIG. 18B is a table of an optical character reader (OCR) setting;

FIG. 19A is a table of security;

FIG. 19B is a table of a network access control;

FIG. 19C is a table of authentication for e-mail transmission,

FIG. 19D is a table of an access right control;

FIG. 20A is a table of system setting information;

FIGS. 20B and 20C are tables of a network setting;

FIGS. 21A and 21B are tables of an e-mail setting;

FIG. 22A is a table of a facsimile setting;

FIG. 22B is a table of a file transfer setting;

FIG. 23A is a table of system management;

FIG. 23B is a table of a stored document;

FIG. 23C is a table of history management;

FIG. 23D is a table of security;

FIG. 23E is a table of a date setting;

FIG. 24A is a schematic of a confidential link information table;

FIG. 24B is a table of confidential link information;

FIG. 25A is a schematic of a user login history information table;

FIG. 25B is a table of user login history information;

FIG. 25C is a schematic of a fingerprint information table;

FIG. 25D is a schematic of a personal fingerprint information table;

FIG. 25E is a table of number of residual fingerprint errors; and

FIG. 26 is a flowchart of user authentication processing according to the present embodiment.

### DETAILED DESCRIPTION

Exemplary embodiments of an authentication method according to the present invention will be explained below.

In the explanation below, when words, phrases, or abbreviations expressing goods, a specific image data format, or the like are included, these words, phrases, or abbreviations may be registered trademarks or trademarks of respective manufacturers, organizations, or individuals. These registered trademarks or trademarks are ones used generally or idiomatically in the technical field to which the present invention is applied, and hence explanatory notes therefor may be omitted. Further, for the convenience of description, the content to be originally described in half-size alphanumeric characters may be described in full size alphanumeric characters.

In the embodiment, an example in which the present invention is applied to a digital color multifunction product that has functions of a copy function, a FAX function, a print function, a scanner function, and a function of distributing an input image (a read document image by the scanner function, or an image input by a printer or the FAX function) is shown.

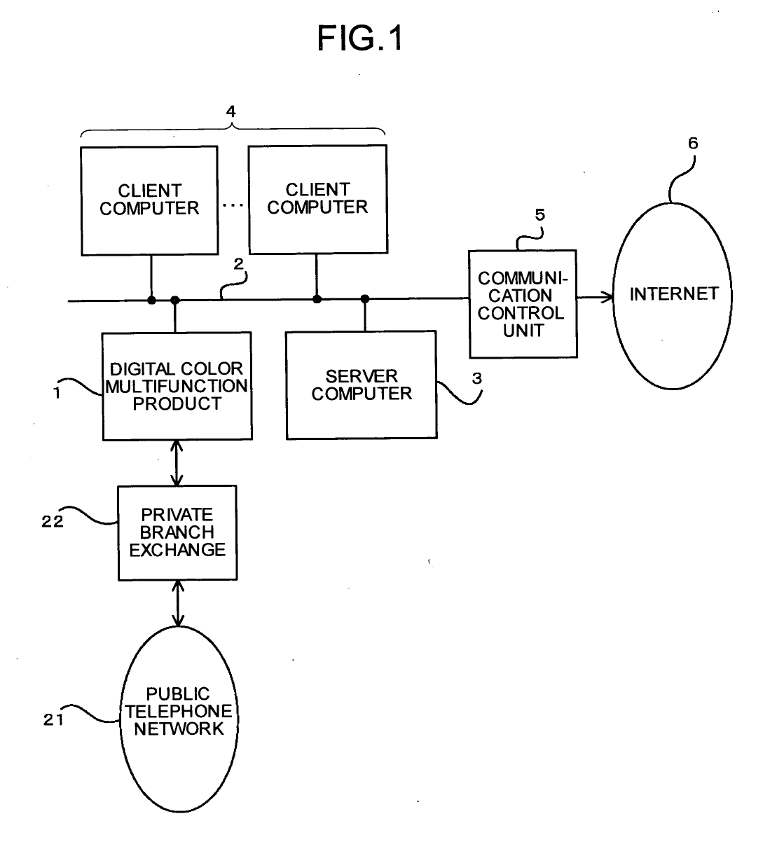

FIG. 1 is a block diagram of a system that includes a digital color multifunction product 1 according to an embodiment. As shown in FIG. 1, the system is assumed in which a server computer 3 that executes various kinds of information processing and a plurality of client computers 4 are connected to the digital color multifunction product 1, which is an information processing system, via a local area network (LAN) as a communication network. The server computer 3 is for supporting, for example, file transfer protocol (FTP) and hypertext transfer protocol (HTTP), and realizing the function of a Web server and a domain name service (DNS) server.

In other words, this system builds an environment such that an image input function (scanner function), an image output function (print function), and an image processing function such as image storing function included in the digital color multifunction product 1 can be shared on the local area network 2.

This system is constructed such that the system is connected to the Internet 6 via a communication control unit 5, and can communicate data with the external environment via the Internet 6.

As the communication control unit 5, a router, a switchboard, a modem, or a digital subscriber line (DSL) modem is generally used, but it is only necessary as a minimum requirement for the communication control unit 5 that Transmission Control Protocol/Internet Protocol (TCP/IP) communications are possible. The local area network 2 is not limited to wire communications, and may be radio communications (infrared or radio wave), or the one using optical fibers.

The digital color multifunction product 1 will be explained next.

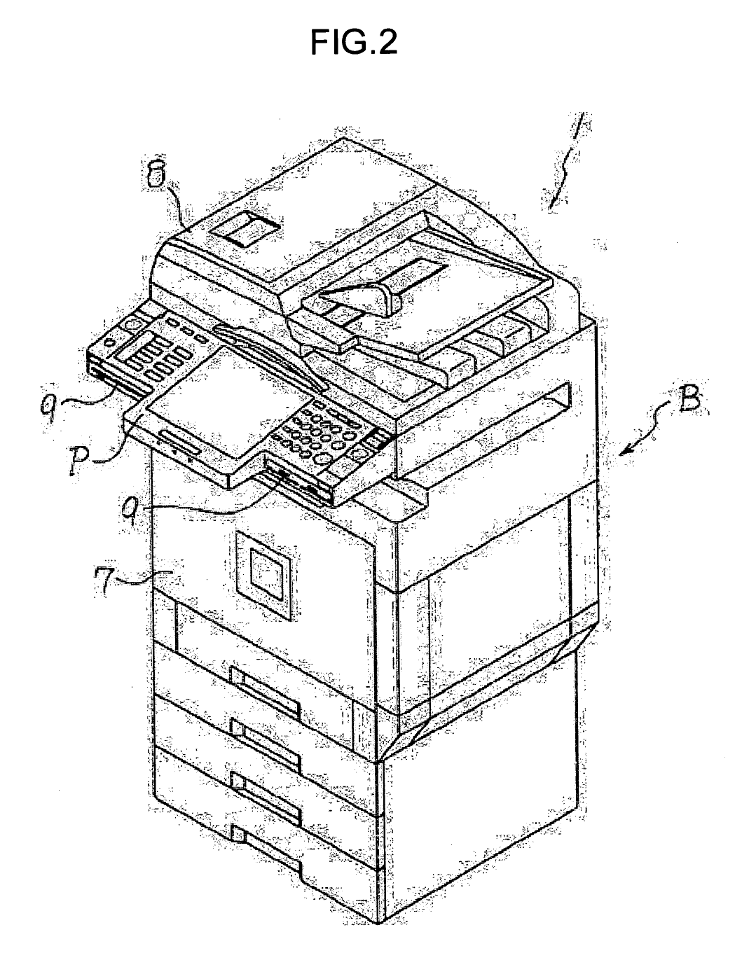

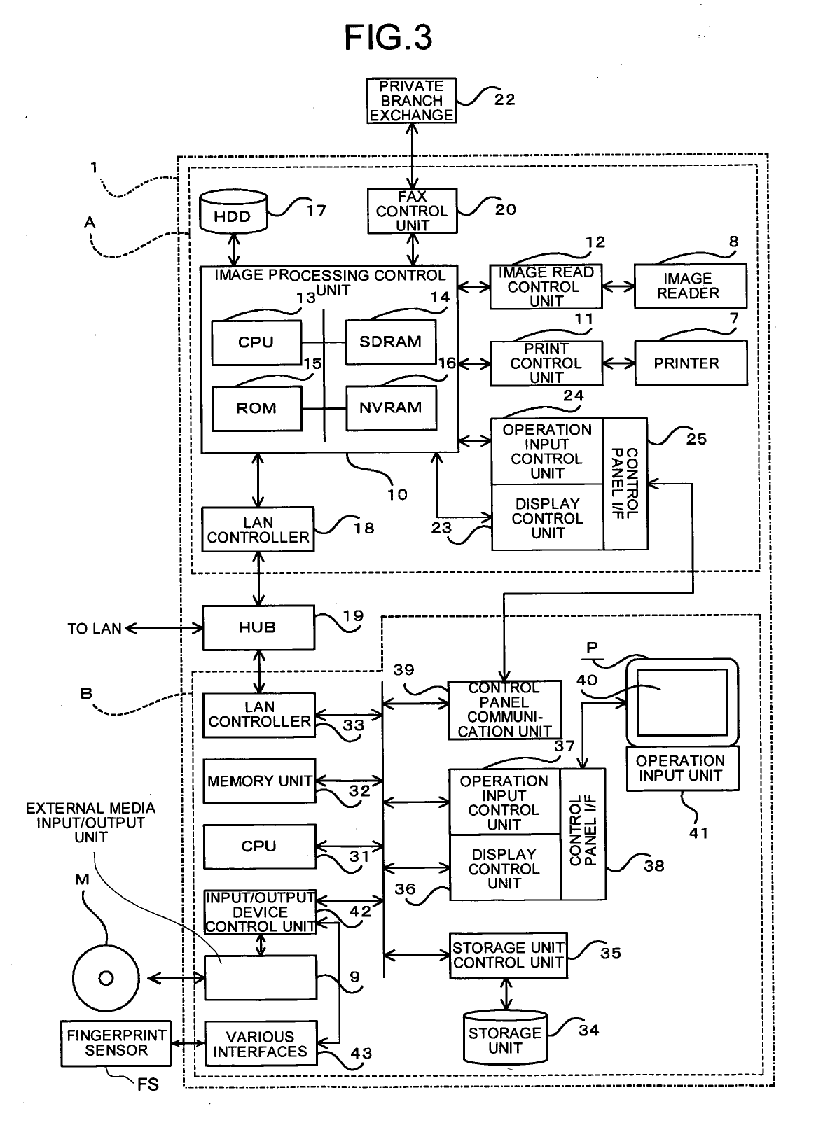

FIG. 2 is a perspective view schematically depicting the appearance of the digital color multifunction product 1, and FIG. 3 is a block diagram of the electric connection between respective parts of the digital color multifunction product 1.

As shown in FIG. 2, the digital color multifunction product 1 has a configuration such that an image reader 8 that reads an image from an original document is arranged above a printer 7 that forms an image on a medium such as transfer paper.

An operation panel P that allows various kinds of inputs, such as display to an operator and function setting from the operator, is provided on the outside of the image reader 8.

An external media input/output unit 9, being a unit that reads a program code and image data stored on a recording medium M (see FIG. 3) such as an optical disk or a flexible disk, or writes the program code and image data onto the recording medium M is provided on the lower part of the operation panel P, with an insertion port for allowing insertion of the recording medium M being exposed toward the outside.

The structure of the digital color multifunction product 1 is largely divided into an image processing unit A and an information processing unit B, as shown in FIG. 3. The printer 7 and the imager reader belongs to the image processing unit A, and the operation panel P and the external media input/output unit 9 belong to the image processing unit B, which becomes a computer for performing various kinds of information processing.

The image processing unit A including the printer 7 and the image reader 8 includes an image processing control unit 10 that controls the entire image processing in the image processing unit A, and the image processing control unit 10 is connected with a print control unit 11 that controls the printer 7, and an image read control unit 12 that controls the image reader 8.

The print control unit 11 outputs a print instruction including image data to the printer 7, so that the printer 7 forms an image on a medium such as transfer paper and outputs the image, under the control of the image processing control unit 10. The printer 7 can print a full color image, and the printing method thereof includes various methods such as an inkjet printing method, a sublimation dye transfer printing method, a silver salt photographic method, a direct thermal recording method, and a thermofusible transfer method, as well as the electrographic method.

The image read control unit 12 drives the image reader 8 under control of the image processing control unit 10, condenses the reflected light irradiated from a lamp with respect to the surface of the document onto a photodetector (for example, a charge coupled device (CCD)) by a mirror and a lens to read the document, and creates digital image data of eight bits for each of red/green/blue (RGB) by A/D conversion.

The image processing control unit 10 has a configuration of a microcomputer in which a central processor (CPU) 13, being a main processor, a synchronous dynamic random access memory (SDRAM) 14 that once stores image data read from the image reader 8 so as to be used for imaging by the printer 7, a read only memory (ROM) 15 that stores a control program and the like, and non volatile random access memory (NVRAM) 16 that can hold data even at the time of power OFF, which records system log, system setting, log information and the like are connected to each other through a bus.

An HDD (magnetic disk unit) 17, which stores a large amount of image data and job history and the like, a local area network controller 18 that connects the image processing unit A to the local area network 2 via an HUB 19, which is a concentrator in the internal local area network provided within the apparatus, and a FAX control unit 20 that controls the facsimile are respectively connected to the image processing control unit 10.

The FAX control unit 20 is connected to a private branch exchange (PBX) 22 connected to a public telephone network 21, and the digital color multifunction product 1 can communicate with a remote facsimile machine.

A display control unit 23 and an operation input control unit 24 are further connected to the image processing control unit 10. The display control unit 23 outputs an image display control signal to the information processing unit B via a communication cable 26 connected to a control panel interface 25 under control of the image processing control unit 10, to control image display with respect to the operation panel P in the information processing unit B.

The operation input control unit 24 inputs an input control signal corresponding to a function setting or an input operation by an operator from the operation panel P in the information processing unit B via the communication cable 26 connected to a control panel interface 25, under control of the image processing control unit 10.

In other words, the image processing unit A has a configuration such that it can directly monitor the operation panel P in the information processing unit B via the communication cable 26.

Therefore, the image processing unit A connects the communication cable 26 to the image processing unit included in a conventional image processor, so as to use the operation panel P in the information processing unit B.

In other words, the display control unit 23 and the operation input control unit 24 in the image processing unit A operate as the one connected to the operation panel P.

By such a configuration, the image processing unit A analyzes print data, being image information from external devices (the server computer 3, the client computer 4, a facsimile machine, and the like) and a command for instructing printing, develops the bit map so that the print data can be printed out as output image data, analyzes the printing mode from the command, and determines the operation. The print data and the command are received from the local area network controller 18 or the FAX control unit 20 and operated.

The image processing unit A can transfer the print data stored in the SDRAM 14 and the HDD 17, data read from the document, output image data obtained by processing the data read from the document for output, and compressed data obtained by compressing the data read from the document to external devices (the server computer 3, the client computer 4, facsimile machine, and the like).

The image processing unit A transfers the image data read by the image reader 8 to the image processing control unit 10, corrects signal deterioration accompanying the optical system and quantization to a digital signal, and writes the image data in the SDRAM 14. The image data stored in the SDRAM 14 is converted to the output image data by the print control unit 11, and output to the printer 7.

The information processing unit B including the operation panel P will be explained next.

The information processing unit B has a configuration of a microcomputer such that it is controlled by a general-purpose operating system (OS) used for information processor, such as a general personal computer. The information processing unit B has a CPU 31, being the main processor. A memory unit 32 formed of a random access memory (RAM) that becomes a work area for the CPU 31, a ROM, which is a read only memory storing a startup program and the like, and a storage unit control unit 35 that controls input and output of data with respect to a storage unit 34 such as an HDD that stores the OS and the application program are connected to the CPU 31 through the bus.

Further, to the CPU 31 is connected a local area network controller 33, being a communication interface for connecting the information processing unit B to the local area network 2 via the HUB 19. The IP address, being a network address allocated to the local area network controller 33, is different from the IP address allocated to the local area network controller 18 in the image processing unit A.

That is, two IP addresses are allocated to the digital color multifunction product 1 in the embodiment.

In other words, the image processing unit A and the information processing unit B are respectively connected to the local area network 2, and data exchange is possible between the image processing unit A and the information processing unit B.

Since the digital color multifunction product 1 is connected to the local area network 2 via the HUB 19, apparently, it can be seen such that only one IP address is allocated. Therefore, connection can be easily handled without damaging the appearance.

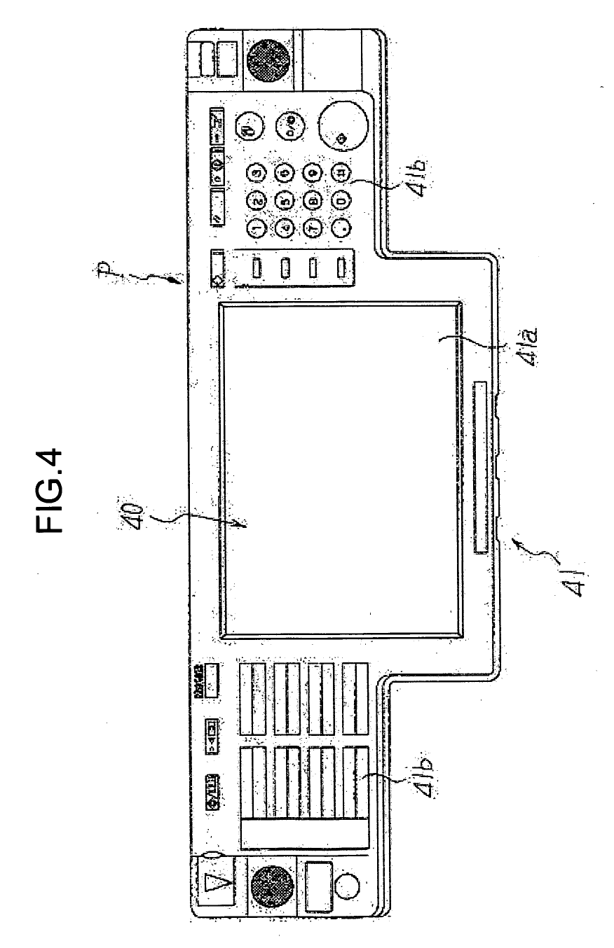

Further, a display control unit 36 and an operation input control unit 37 for controlling the operation panel P are connected to the CPU 31. FIG. 4 is a plan view of the configuration of the operation panel P.

As shown in FIG. 4, the operation panel P includes a display unit 40, which is for example a liquid crystal display unit (LCD), and an operation input unit 41. The operation input unit 41 includes a touch panel 41a of a ultrasonic sound wave method laminated on the surface of the display unit 40, and a keyboard 41b having a plurality of keys.

The keyboard 41b is provided with a start key for declaring start of image read, a ten key for inputting numeric values, a read condition setting key for setting a destination of the read image data, a clear key, and the like.

In other words, the display control unit 36 outputs an image display control signal to the display unit 40 via the control panel interface 38, so that the display unit 40 displays predetermined matter corresponding to the image display control signal. On the other hand, the operation input control unit 37 receives an input control signal corresponding to the function setting and input operation by the operator in the operation input unit 41 via the control panel interface 38.

Further, to the CPU 31 is connected a control panel communication unit 39, which is connected to the control panel interface 25 in the image processing unit A via the communication cable 26.

The control panel communication unit 39 receives the image display control signal output from the image processing unit A, and transfers the input control signal corresponding to the function setting and input operation by the operator from the operation panel P to the image processing unit A.

Though detailed explanation will be given later, the image display control signal from the image processing unit A received by the control panel communication unit 39 is converted to data for the display unit 40 on the operation panel P and output to the display control unit 36. The input control signal corresponding to the function setting and input operation by the operator from the operation panel P is data-converted to a format corresponding to the specification in the image processing unit A and input to the control panel communication unit 39.

The OS and the application program executed by the CPU 31 are stored in the storage unit 34. In this sense, the storage unit 34 functions as a recording medium that stores the application program.

When the user turns on the power of the digital color multifunction product 1, the CPU 31 starts up the startup program in the memory unit 32, reads the OS from the storage unit 34 into the RAM in the memory unit 32, to start up the OS. The OS starts up a program, reads information, and stores information, corresponding to the operation of the user. As a representative OS, Windows (registered trademark) system and the like are known. The operating program operated on the OS is referred to as an application program. The OS of the information processing unit B is the same as that of the information processing unit (the server computer 3, the client computer 4, and the like), that is, the general-purpose OS (for example, Windows, etc.)

The external media input/output unit 9 such as a flexible disk drive, an optical disk drive, an magneto-optical (MO) drive, a media drive or the like, which is a device that reads program codes and image data stored on a recording medium M recording the OS, various program codes (control programs) such as device driver and various application programs, and image data, that is, flexible disk, hard disk, optical disk (CD-ROM, CD-R, CD-RW, DVD-ROM, Dvb-RAM, DVD-R, DVD+R, DVD-RW, DVD+RW, etc.), MO disk, or semiconductor media, or writes program codes and image data into the recording medium M, is installed in the digital color multifunction product 1 in the embodiment. The external media input/output unit 9 is controlled by an input/output device control unit 42 connected to the CPU 31 via the bus.

Therefore, the application program stored in the storage unit 34 may be the one obtained by installing the application program stored on the recording medium M.

Accordingly, the recording medium M can be a recording medium for storing the application program. Further, for example, the application program may be taken into and installed in the storage unit 34 from the external device via the Internet 6 and the local area network 2.

Various interfaces 43 such as a universal serial bus (USB), Institute of Electrical and Electronics Engineers (IEEE) 1394, small computer system interface (SCSI), and the like are connected to the input/output device control unit 42, so that various types of equipment, such as a digital camera, can be connected thereto via the various interfaces 43.

In this case, a fingerprint sensor FS for inputting fingerprint information is connected to various interfaces 43. The fingerprint sensor FS is a well known type, which uses, for example, a capacitance type fingerprint sensor (a capacitance type semiconductor sensor), to detect a fingerprint and perform image recognition, detects information indicating characteristic points of the fingerprint included in the recognized image data as fingerprint information, and outputs the detection result of the human fingerprint information (including a detection error) and the detected fingerprint information at an interval of, for example, 200 milliseconds. A sensor face of the fingerprint sensor FS on which a user touches by a finger is arranged at an appropriate position in the operation input unit 41, where the user can easily operate, such as an empty space on the right of the ten key 41b.

The characteristic processing executed by the digital color multifunction product 1 will be explained below.

The digital color multifunction product 1 is constructed such that a plurality of devices that performs processing different from each other, in this example, the image processing unit A and the information processing unit B, can perform processing respectively in standalone mode. Therefore, when the image read processing is being performed by the image processing unit A, the information processing unit B can perform different operation, such as receiving an e-mail. In such an example, since the results of the respective processing do not affect each other, there is no problem even if the image processing unit A and the information processing unit B are operating in standalone mode.

In the digital color multifunction product 1, in addition to this, the respective functions of the image processing unit A are used by the program operated by the information processing unit B, and the results thereof can be processed.

For example, such processing may be performed that the image document image data read by the image reader 8 in the image processing unit A is processed by predetermined character recognition software, to obtain a text document. To perform such processing, in the conventional multifunction product, it is necessary that (A) the data to be processed is transmitted to an external computer (personal computer (PC) or the like) having the character recognition software installed therein so as to be processed by the computer, or (B) the image processing unit A prepares the character recognition software so that it is operated by the image processing control unit 10.

As a problem in this case, as to (A), there is a problem in that unless the external computer is prepared at all times, the processing cannot be performed as required. When the software operated by the image processing control unit 10 is prepared as in the case of (B), there are problems in that (C) operation of the general-purpose application software in the system specialized for image processing deteriorates the original processing capacity of the multifunction product, and (D) in the system specialized for image processing, almost all commercially available software such as word processor and speech recognition does not operate because of incompatibility of the operating system, and hence, software development dedicated therefor becomes necessary.

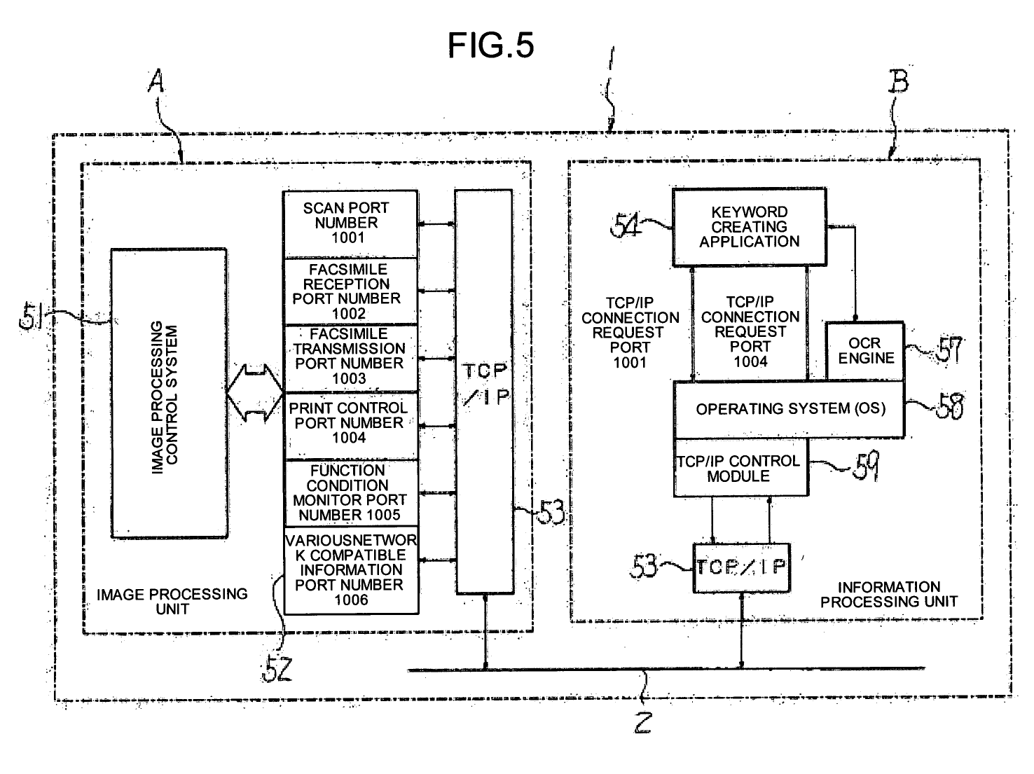

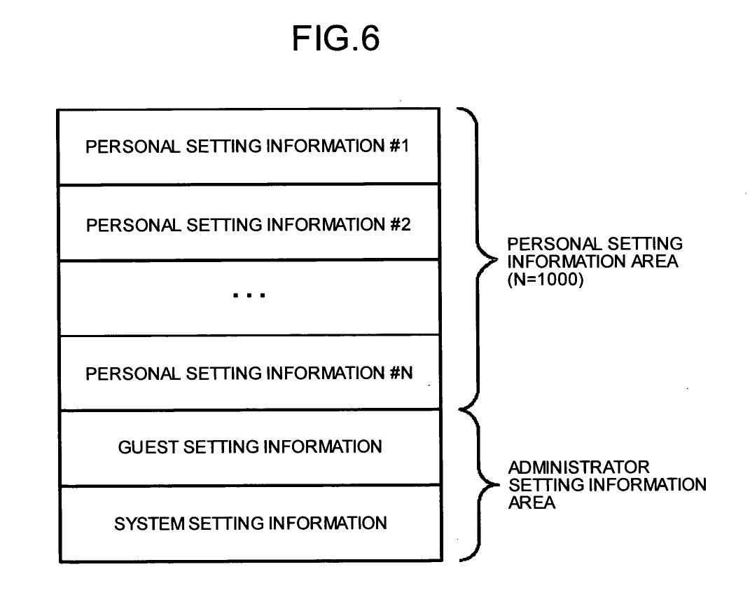

On the other hand, in the digital color multifunction product 1, the so-called commercially available operating system 58 (see FIG. 5, for example, Windows) is operated in the information processing unit B, which is not affected by the operation of the image processing unit A, and hence, there is no problem like (A) and (B) above. However, if the image processing unit A and the information processing unit B operate in standalone mode at all times, such an object cannot be achieved that the respective functions of the image processing unit A are used by the program operated by the information processing unit B, and the results thereof are processed. Therefore, in the digital color multifunction product 1, the respective functions of the image processing unit A can be used by operating the program in combination with the processing module as shown in FIG. 5.

The processing module in FIG. 5 will be explained here.

In FIG. 5, a module in an image processing control system 51 includes a program for performing control so that the original functions of the multifunction product are executed by the digital color multifunction product 1. The digital color multifunction product 1 is provided with an interface with a network compatible functional module 52 that can be accessed only from the information processing unit B via a network (local area network 2).

The network compatible functional module 52 is for allowing the functions normally provided for the general multifunction product, for example, scanning function and FAX receiving function (executed by the image processing control system 51) to be used via the network (local area network 2), and cannot be used by the image processing unit A.

The network compatible functional module 52 has a configuration such that when a transmission control protocol/Internet protocol (TCP/IP) 53, which monitors access from the network at all times, detects a connection request for a corresponding port number, a processing module having the corresponding function is activated.

For example, when there is a connection request for port number 1002, a module of the FAX receiving function is activated. The activated module operates in cooperation with the processing request from the source of the connection request, to return a necessary response.

The characteristics of the program operated by the information processing unit B will be explained next. As an example, a keyword creating application 54 will be explained.

The keyword creating application 54 performs character recognition processing with respect to the read image data, to create a keyword from the character recognition result. In the entire information processing unit B, the respective applications operate under control of the operating system 58.

The respective applications can use the functions provided by the operating system 58. That is, in the program executing the application, the respective applications use the functions in such a form that the function is called up as a module, being a part of the software, to perform necessary processing. As an example, there is a TCP/IP control module 59 or the like. The TCP/IP control module 59 executes a function normally equipped in the operating system 58 for communicating with other terminal units connected via a TCP/IP 53.

Independent software incorporated so as to be used by other applications can be also used. For example, an OCR engine 57 performs only the character recognition processing from the image data. The OCR engine 57 does not operate in standalone mode, and is used as the part (module) of other software.

Thus, since the respective applications can operate under control of the operating system 58 in the information processing unit B as a whole, an application in which a single function is used or a plurality of these functions is combined can be developed.

In the current technique, however, the function of the image processing unit A or the like cannot be directly used by the above method.

In other words, in the digital color multifunction product 1, the image processing unit A for realizing the original function of the multifunction product and the information processing unit B for executing the application software are provided, and connected to each other via the network (local area network 2) by the network protocol (TCP/IP 53).

However, this means that only a physical connection is possible, and hence, data can be communicated between the image processing unit A and the information processing unit B, but the function of the image processing unit A cannot be used by the application software operated by the information processing unit B, only by using the existing technique.

Therefore, the method that allows the function of the image processing unit A to be used by the application software operated by the information processing unit B will be explained here.

For example, the image data to be subjected to character recognition processing is image data read from the image reader 8 controlled by the image processing unit A, in the keyword creating application 54.

To instruct the image read operation with respect to the image reader 8, it is necessary to specify the port number 1001 to request the image processing unit A to connect to the TCP/IP. At this time, the data indicating the processing content is also transmitted as a data stream. The function specified by the port number 1001 is the one for the image reader 8 to perform readout, and transfer the read image data with an optional file number to the information processing unit B side. Such processing content is prearranged, and allocated with a port number for using these functions independently.

Thus, the function of the image processing unit A can be used by the keyword creating application 54.

The communication protocol is not limited to the TCP/IP, and other methods may be used.

The digital color multifunction product 1 basically has a scanner function, a media browser function, a document browser function, a page browser function, an image processing function, a form synthesizing function, a transmission/storage function, a printing function, an OCR function, a search function, a facsimile function, a mail server function, a Web server function, a regular execution function, a system monitoring function, a security function, a history/status display function, a personal setting function, and administrator setting function, and the like.

With the scanner function, paper document is read in a form of image file, and transmitted by an e-mail, by facsimile, or by file transmission (shared folder in Windows, FTP folder, Web folder, or external server). Alternatively, the paper document may be stored therein.

With the media browser function, files stored in a recording medium M can be read. Further, by setting the shared folder, FTP folder, or Web folder on the network as shared (virtual) media in personal setting, these folders can be read by the same operation as in the media.

With the document browser function, the stored file groups (documents), such as storage of general documents (temporary storage), received e-mails (storage of images attached to the received e-mails), received facsimiles (storage of facsimile images), can be operated and read. Further, a document management function is also provided, so that the document name can be changed, and a document can be deleted. The stored document can be read by the OCR to search a character in the image, or can be downloaded from websites.

With the page browser function, images in the apparatus body, which are present in the stored documents or transmitted or printed images can be displayed. Selection of functions for transmitting or storing an image file or printing the image, and reading and editing of various types of information in the file are also possible.

The image processing function includes an automatic image processing function that enables image operation before transmission, storage, or printing of the image. It also enables correction of image quality and rotation of images, color subtraction, clipping, or batch removal.

With the form synthesizing function, position information with background, to which a text or an image is attached, can be selected and synthesized before transmission, storage, or printing of the image, to create a new image. By cooperating with a form creation tool, transmission images and printed matter in various layouts can be created.

With the transmission/storage function, images or files selected by a paper document (scan), the media browser, or the document browser (page browser) can be transmitted to a specified destination by e-mail transmission or facsimile transmission, or to the shared folder, FTP folder or Web folder on the network, or to an external server. By storing the images, the images can be read by the OCR to search a character string, or can be downloaded from the websites.

With the printing function, images and files selected by the media browser or the document browser (page browser) can be specified and printed in various layouts (forms).

With the OCR function, texts can be extracted from images obtained by scanning paper or from received facsimile images by character recognition (OCR). The OCR function includes a function of creating a portable document format (PDF) file (image PDF+OCR) including a text padded therein to transmit and store the PDF file, an OCR text search function at the time of storage, and an OCR destination/document name/subject/text function of using the character string obtained by OCR as the destination/document name/subject/text. As the OCR destination, the OCR character string in a specified area agreeing with a registered destination is used. As the OCR document name/subject/text, the OCR character string in a specified area is used.

With the search function, the document name or file name, stored date and time or updated date and time, or an OCR text is used as a keyword to extract and display an image or a file stored or present on the network having a content agreeing with the keyword. The object of the OCR text search is character strings obtained from an image by OCR.

With the facsimile function, image information received from facsimile ports (up to three facsimile communication ports: G3-1, G3-2, G4-1) prepared by the digital color multifunction product 1 is stored in an image file, and distributed by transfer (e-mail transfer or file transfer). The received facsimile can be distributed to destinations by sender and by reception port according to the initial setting. Further, image files from paper document, media, and storage can be transmitted by facsimile, or an image attached to a received e-mail can be transferred to other facsimile machines.

The mail server function includes a function of transmitting e-mails, and a function of creating and holding an e-mail address for a guest and a person (at the time of setting small mail transfer protocol (SMTP)), automatically printing or transferring by facsimile the image attached to the received e-mail, or performing transmission/storage one-touch operation, and transmitting an operation result e-mail to a sender.

As to a reception e-mail address, various operation combinations are prepared as default for each guest and person, and setup and change are made in the personal setting.

The same operation as that of at the time of SMTP setting can be performed by dispatching the e-mail address of an external mail server (at the time of post office protocol (POP) reception setting) by e-mail address display name. To correspond to various e-mail environments, e-mail transmission corresponds to SMTP authentication and the “POP before SMTP” mode, and e-mail reception also corresponds to authenticate POP (APOP).

With the Web server function, uniform research locator (URL) is respectively prepared for each guest and person, and images and files stored therein can be read, searched, downloaded, uploaded, transmitted/stored, or printed, the operation result can be referred, and setting by person or administrator can be performed. Security during communication is taken into consideration, and the Web server function can correspond to secure socket layer (SSL) server authentication.

With the regular execution function, deletion of the stored content whose storage time limit has expired, reception of POP e-mails, update of lightweight directory access protocol (LDAP), automatic printing and deletion of history, and automatic restart are possible.

With the system monitoring function, disk full state, abnormality occurred in the apparatus, tray/door half-open indication, and paper jam are detected, to display a screen for displaying a message (including a service call (SC screen)). Further, it can correspond to an accounting device that monitors and restricts the use by the user.

With the security function, to protect the data from being used illegally by a passing user (guest user) or from an external network, security with respect to a user of the operation unit (individual authentication function, administrator password and the like), and security with respect to the network (authentication of e-mail transmission, APOP, SSL server authentication of the website, restriction of access, and the like) can be realized.

With the history/status display function, it can be determined whether transfer of e-mails, facsimile, and files and the printing result are normal, executed and finished date and time can be confirmed, and cancellation of a job and the content of error at the time of execution can be confirmed.

With the personal setting function, environment setting for each person can be registered, without the use environment of an individual user (e-mail address registration, screen/operation customization, reception e-mail address setting, and the like) being seen from others. The settable number of persons is 1000.

With the administrator setting function, various setting function with respect to guest users, basic functions (network setting, time setting, and automatic restart time) for operating the various functions, and an administration function (user control, e-mail environment setting, receive facsimile setting, and the like) can be set.

To realize these various functions, the information processing unit B in the digital color multifunction product 1 is provided with a personal setting information area in which personal setting information for 1000 persons can be registered, and an administrator setting information area in which guest setting information and system setting information are registered.

Specific examples of the personal setting information, the guest setting information, and the system setting information will be explained below. Since the contents of the guest setting information are basically the same as those of the personal setting information, only a portion thereof different from the contents of the personal setting information will be explained, and explanation for other portions is omitted. The combination of various information elements in the explanation and specific contents of the respective information elements are only illustrative and not restrictive. Further, in the explanation of contents of the respective information elements, the content in brackets indicates one example of a value that can be taken by the relevant information element and the explanation (a part) thereof.

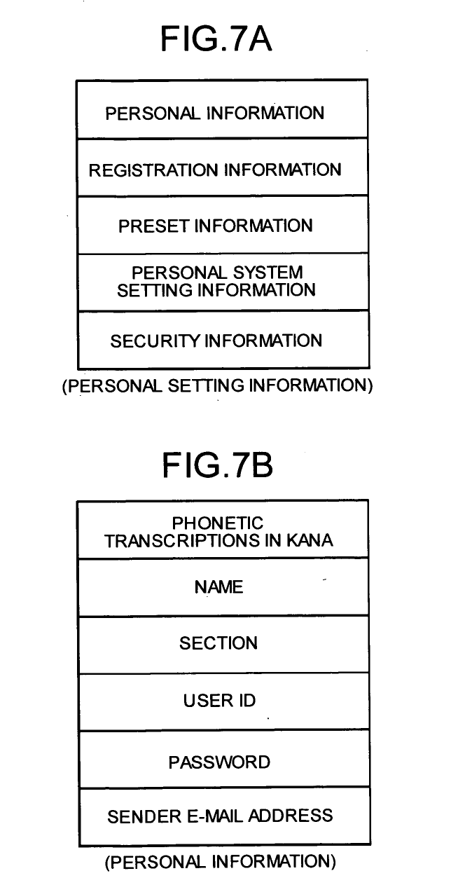

The personal setting information includes, for example as shown in FIG. 7A, personal information for identifying respective individuals, registration information for registering e-mail address for each person, preset information for registering various condition setting information for each person, personal system setting information for storing initial setting and the like at the time of using the digital color multifunction product 1, and security information for registering information relating to the security.

The personal information includes, for example as shown in FIG. 7B, “phonetic transcriptions in kana”, “name”, “section” expressing a section or department in which the person works, “user ID” for identifying each person, “password” used for authentication, and “sender e-mail address”.

As to the “name”, only names unique in the system of the digital color multifunction product 1 can be set, and for example, the name is used as a title of personal menu, and is a character string expressing each user.

The “user ID” is used, at the time of starting operation, when the user proceeds from a guest menu (initial setting state) to a personal menu, and is also used for a URL for personal menu in a Web (example, http://host name/“user ID”), and for a reception e-mail address (example, print.“user ID”@host name.domain name).

The “sender e-mail address” is a character string set in the “From” field at the time of transmitting an e-mail, and in the case of default, it is automatically set in association with setting of the e-mail reception protocol in the administrator setting.

For example, when the e-mail reception protocol is set to POP or APOP, “name (of personal information) [sender.user ID]<POP e-mail address>” is set as a sender e-mail address in the case of default.

When the e-mail reception protocol is SMTP, “name (of personal information) sender.user ID@host name.domain name” is set as a sender e-mail address in the case of default.

The “sender” here is the default of reception e-mail address of [01] error e-mail in an incoming mailbox (described later). Therefore, after transmission of an e-mail, an error e-mail is transferred due to unknown destination, it is accumulated in “error e-mails” in the incoming mailbox.

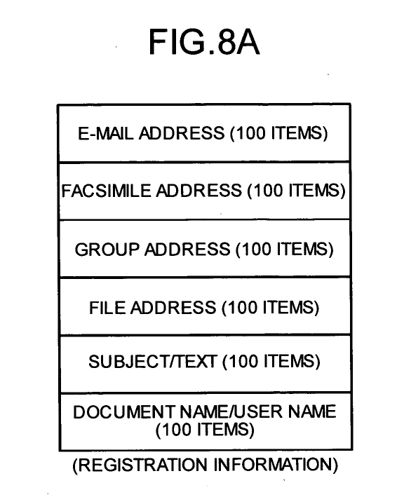

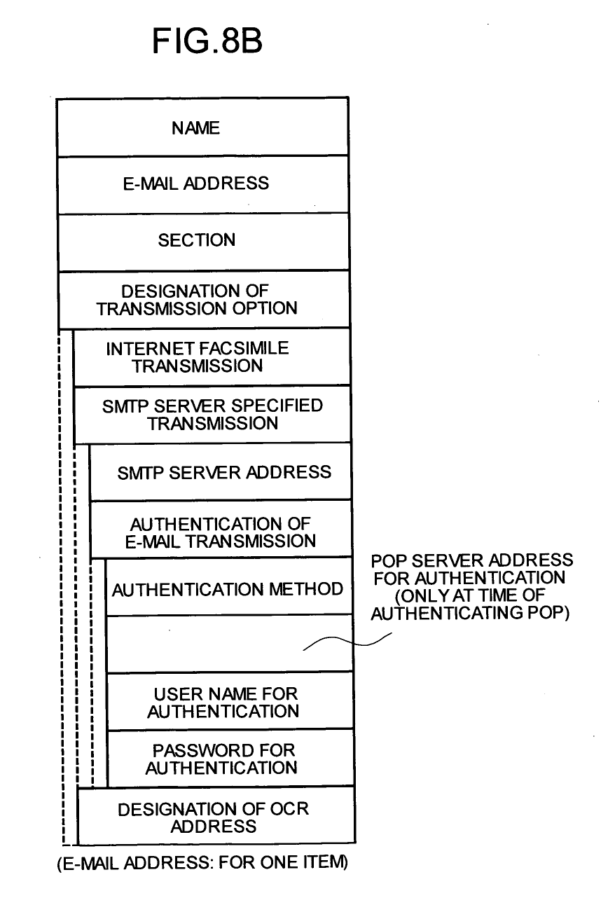

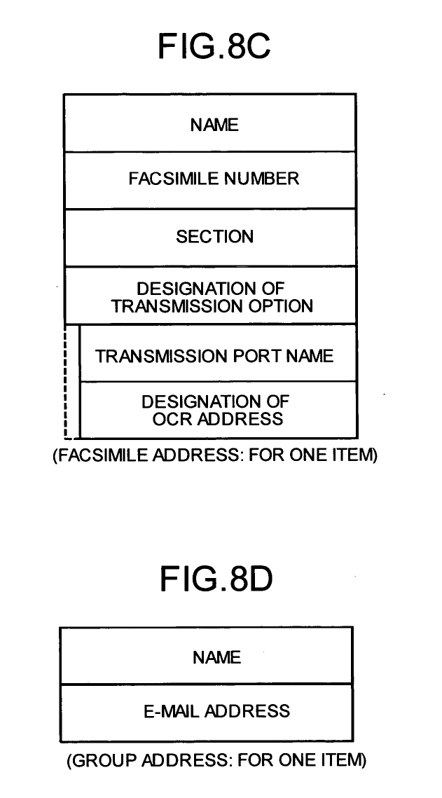

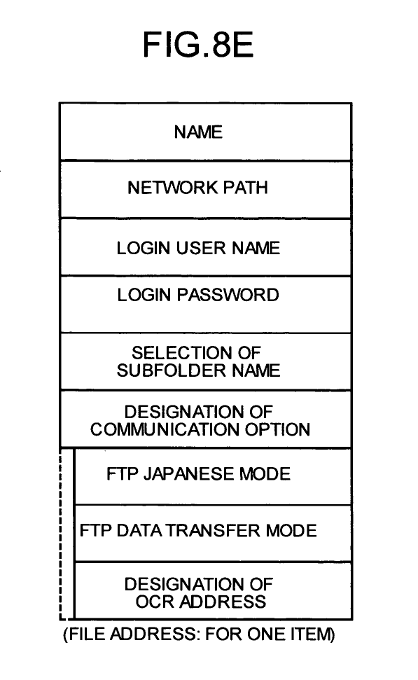

The registration information includes, for example as shown in FIG. 8A, e-mail address (100 items) used as an address at the time of transmitting an e-mail, facsimile address used as an address at the time of sending a facsimile (100 items), group address (100 items), and file address (100 items) used as an address at the time of transmitting a file, for example, subject/text (100 items), being an subject set in a “Subject” field or the content set in the text information of an e-mail at the time of transmitting the e-mail, and document name or user name (100 items).

The e-mail address includes, for example as shown in FIG. 8B, “name”, “e-mail address”, “section”, and “designation of transmission option (Yes, No)”. When the “designation of transmission option” is set to “Yes”, it further includes “Internet facsimile transmission” expressing whether to perform Internet facsimile transmission, “SMTP server address” at the time of specifying the SMTP server, “authentication of e-mail transmission (Yes, No)” expressing whether to perform authentication at the time of e-mail transmission, and “designation of OCR address (Yes, No)”.

When the “authentication of e-mail transmission” is set to “Yes”, it includes “POP server address for authentication”, “user name for authentication”, and “password for authentication”.

All files to be attached to the e-mail address at which the “Internet facsimile transmission” is set to “Yes” are converted to network facsimile images (Tag Image File Format class-F: TIFF-F) and transmitted.

When the “designation of OCR address” is set to “Yes”, and at the time of failure of the OCR, or mishit of the address, the e-mail is transmitted to a registered e-mail address.

The e-mail address can be registered from an e-mail address obtained from the mail server (by LDAP) (using a public address book function).

The facsimile address includes, for example as shown in FIG. 8C, “name”, “facsimile number”, “section”, and “designation of transmission option (Yes, No)”.

As to the “name (personal address)”, the same value in the personal facsimile address cannot be registered.

When the “designation of transmission option” is set to “Yes”, it further includes “transmission port name” and “designation of OCR address (Yes, No)”. When the “designation of OCR address” is set to “Yes”, and when the OCR is defective, or the address is not hit, the e-mail is transmitted to a registered e-mail address.

The group address includes, for example as shown in FIG. 8D, “name” for identifying a group address, and “mail name” in which one or more e-mail address names are registered.

As to the “name (group)”, the same value in the personal group address cannot be registered. Further, the same e-mail address cannot be registered in one group.

The file address includes, for example as shown in FIG. 8E, “name” for identifying the file address, “network path” in which a network path value for being used at the time of transmitting a file to the shared folder in Windows, FTP folder, or HTTP (external server) folder on the network is registered, “login user name”, “login password”, “selection of subfolder name” for registering a subfolder name to be created in the host apparatus at the file address, and “designation of communication option (Yes, No)”.

When the “designation of communication option” is set to “Yes”, it further includes “FTP Japanese mode (shift Japan industry standard (JIS), extended Unix cord (EUC))”, “FTP data transfer mode (PORT mode, PASV mode)”, and “designation of OCR address”.

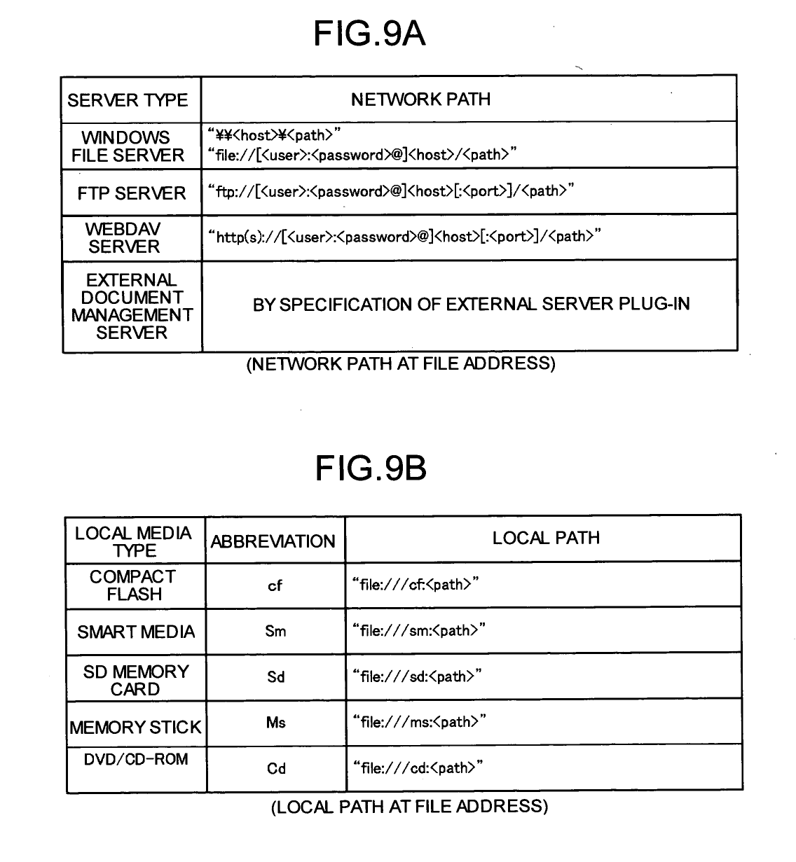

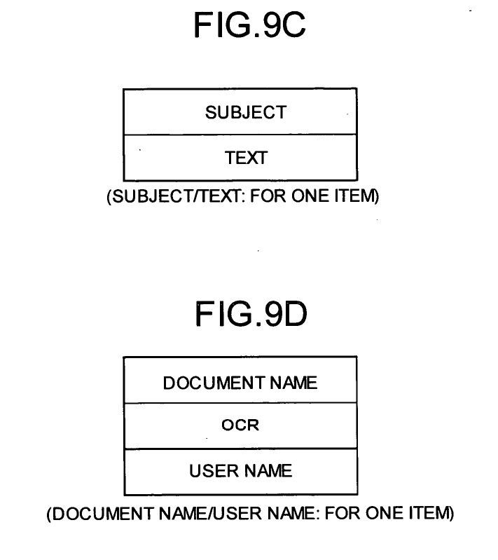

The “network path” here includes a local path as shown in FIG. 9B, other than the network path shown in FIG. 9A.

The “external server plug-in” in the drawing refers to a function by which file transmission to an external server is made possible, and shared media can be specified, without noticing a difference in interface, in the same image as that of the scheme such as file, ftp, and http(s), with respect to various external servers. Further, “compact flash”, “smart media”, “secure digital (SD) memory card”, and “memory stick” are registered trademarks of respective manufacturers.

The subject/text includes, for example as shown in FIG. 9C, “subject” under which a character string used as a subject at the time of transmitting an e-mail is registered, or “text” in which character strings in the text at the time of transmitting the e-mail is registered.

The document name/user name includes, for example as shown in FIG. 9D, “document name” under which a character string used as a document name at the time of storage is registered, “OCR (Yes, No)”, and “user name” under which a regular character string used as the user name (document name at the time of transmitting a file) is registered.

When the “OCR” is set to “Yes”, and at the time of failure of the OCR, the registered document name is used.

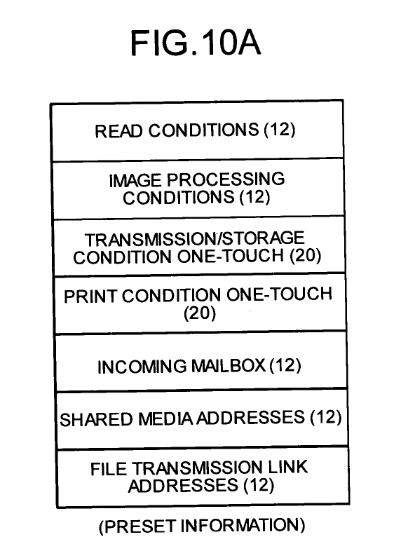

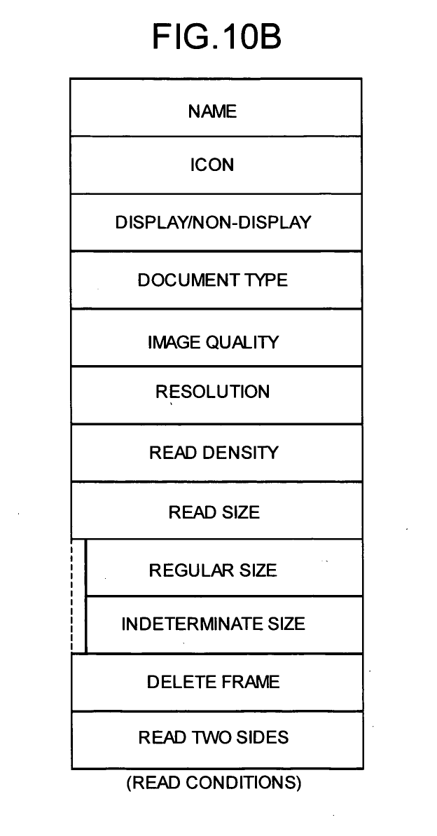

The preset information includes, for example as shown in FIG. 10A, read conditions (12), image processing conditions (12), transmission/storage condition one-touch (20), print condition one-touch (20), incoming mailbox (12), shared media addresses (12), and file transmission link addresses (12).

The read conditions, image processing conditions, and the file transmission link addresses are contents registered to preset buttons displayed on an operation screen, the transmission/storage condition and the print condition are contents registered to one-touch buttons displayed on the operation screen, and the incoming mailbox, shared media addresses, and the file transmission link addresses are contents registered to button icons displayed on the operation screen.

When the respective preset buttons, one-touch buttons, and button icons are operated, the contents registered to the respective preset buttons, one-touch buttons, and button icons are applied to the operation or the like at that time, and the operation is executed.

The read conditions includes, for example as shown in FIG. 10B, “name” for identifying the read condition on a preset button, “icon” for specifying an icon for displaying a simple image of the read conditions on the preset button, “display/non-display” for specifying whether to display the read conditions (when it is to be displayed, specification of the display mode is included), “document type (black and white characters, black and white photograph, grayscale, and full color) for specifying the type of the read document, “image quality (select from 9 levels of from “give priority to compression” to “give priority to image quality”) for specifying the read image quality, “resolution (100 dots per inch (dpi), 200 dpi, 300 dpi, 400 dpi, and 600 dpi)” for specifying the read resolution, “read density (either automatic density or 7 levels of manual density)” for specifying the read density, “read size (automatic size detection, regular size, indeterminate size)” for specifying the read range on the read document, “delete frame (Yes, No)” for specifying that a frame area of the read range specified by the read size is deleted, and “read two sides” for specifying whether to perform two-sided read”.

When the “read size” is other than the “automatic size detection”, a specified value is set in the “regular size” or in the “indeterminate size”, respectively.

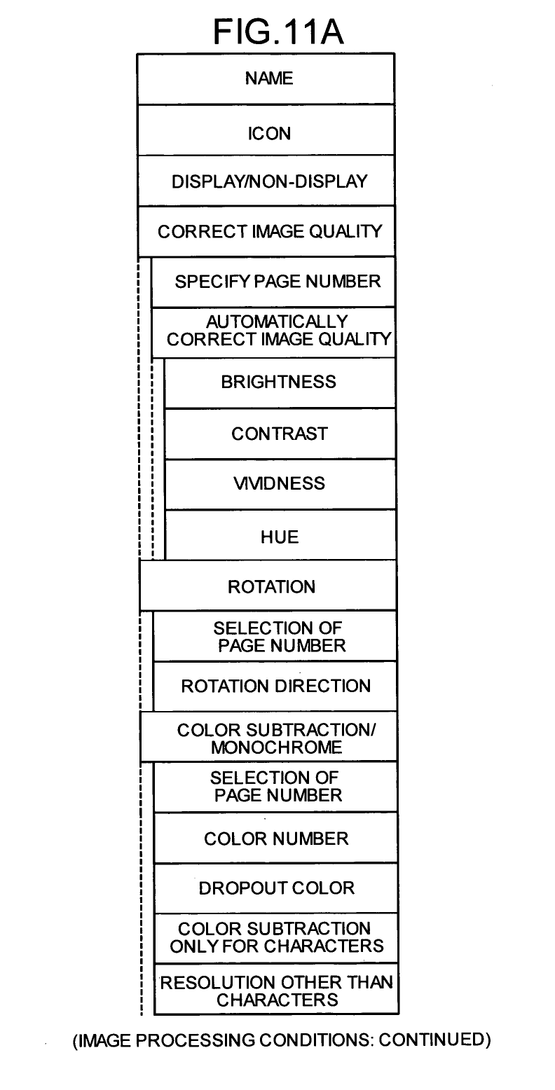

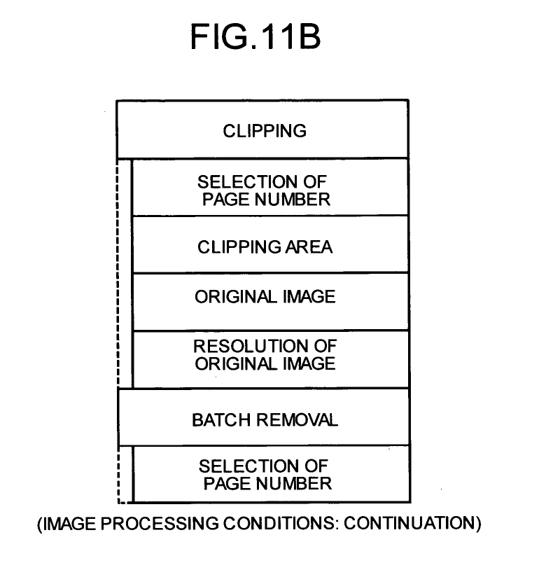

The image processing conditions include, for example as shown in FIGS. 11A and 11B, “name” for identifying the image processing condition on the preset button, “icon” for specifying an icon for displaying a simple image of the image processing conditions on the preset button, “display/non-display” for specifying whether to display the image processing conditions (when it is to be displayed, specification of the display mode is included), “correct image quality (Yes, No)” for specifying whether to correct the image quality, “rotation (Yes, No)” for specifying whether to rotate the image, “color subtraction/monochrome (Yes, No)” for specifying whether to perform color subtraction processing or monochrome processing, “clipping (Yes, No)” for specifying whether to perform clipping of the image, and “batch removal.” for specifying whether to perform batch removal for removing a blank image.

When the “correct image quality” is set to “Yes”, it further includes “selection of page number” for specifying a page number to which the image quality correction is applied, and “automatically correct image quality (automatic, manual)” for setting the content of image quality correction. When the “automatically correct image quality” is set to “manual”, “brightness”, “contrast”, “vividness”, and “hue”, which are image quality correction items set manually, are included therein.

When the “rotation” is set to “Yes”, it further includes “selection of page number” for specifying a page number to which rotation is applied, and “rotation direction” for specifying the rotation direction.

When the “color subtraction/monochrome” is set to “Yes”, “selection of page number” for specifying a page number to which color subtraction or monochrome processing is applied, “color number” for specifying the color number after color subtraction, “dropout color (none, red, blue, green, chromatic color)” for specifying the dropout color, “color subtraction only for characters” for specifying whether to apply color subtraction or monochrome processing only to characters, and “resolution other than characters (as it is, ½, ¼)” for specifying whether to change the resolution of the image after color subtraction.

When the “clipping” is set to “Yes”, it further includes “selection of page number” for specifying a page number to which clipping is applied, “clipping area (select from existing form data and form data obtained by specifying the area of the read image or the selected image and storing the image)” for specifying an image area to be clipped, “original image (leave or not to leave the original image, add before the original image, or add after the original image)” for specifying how to handle the original image, and “resolution of the original image (as it is, ½, ¼)” for specifying how to handle the resolution of the original image, when the original image is to be left.

When the “batch removal” is set to “Yes”, it further includes “selection of page number” for specifying a page number to which batch removal processing is applied.

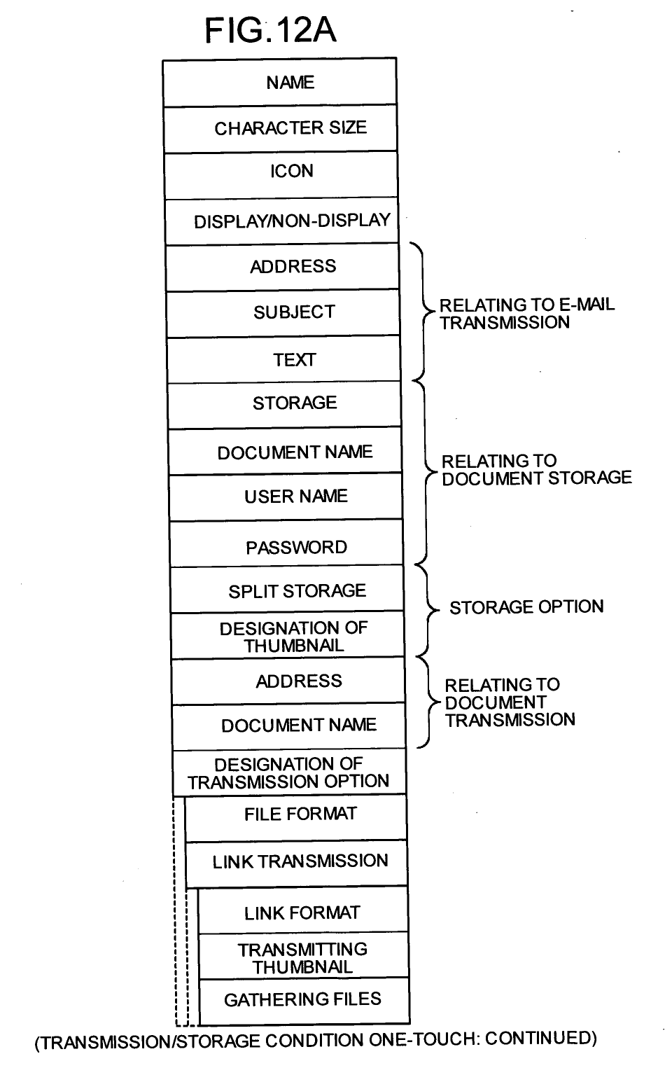

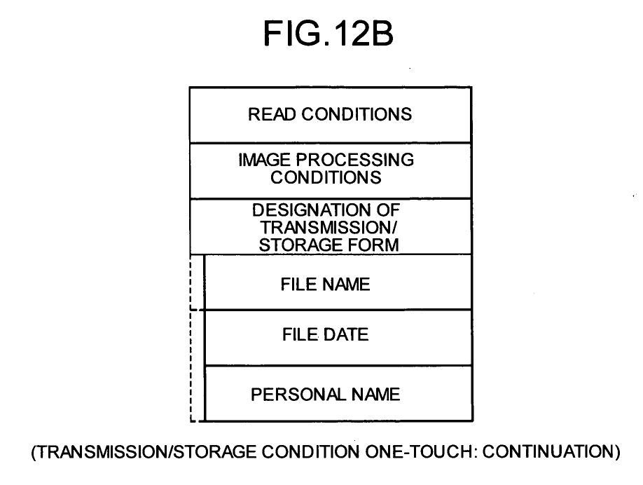

The transmission/storage condition one-touch includes, for example as shown in FIGS. 12A and 12B, “name” for identifying the transmission/storage condition on the one-touch button, “character size” for specifying the character size applied at the time of displaying the name on the one-touch button, “icon” for specifying an icon for displaying a simple image of the transmission/storage conditions on the one-touch button, “display/non-display” for specifying whether to display the transmission/storage conditions (when it is to be displayed, specification of the display mode is included), “addresses (up to 100)” in which one or more addresses at the time of e-mail transmission are registered, “subject” in which subjects at the time of e-mail transmission are registered, “text” in which the text content at the time of e-mail transmission is registered, “storage (to store it or not, to make it public or not) for specifying whether to store the document and whether to make the document public, “document name” in which the document name at the time of storing the document is registered, “user name” in which the user name requested in the authentication operation applied at the time of referring to the stored document is registered, “password” in which a password requested in the authentication operation applied at the time of referring to the stored document is registered, “split storage (Yes (number of pages of the document), No) for specifying whether to perform split storage at the time of storing the document, “designation of thumbnail (Yes (selection of page number and area), No)” for specifying whether to specify the page number and image area for creating a thumbnail image for the stored document, “address” in which addresses at the time of file transmission are registered, “document name” in which document names at the time of file transmission are registered, “designation of transmission option (Yes, No)” indicating whether to specify the transmission option, “read conditions” for specifying the read conditions at the time of creating an image, “image processing conditions” for specifying the image processing conditions at the time of creating an image, and “specify transmission/storage form (Yes (select from form data), No” indicating whether to specify the form at the time of transmission/storage.

When the “designation of transmission option” is set to “Yes”, it further includes “file format (no change, image file, image PDF, image PDF+OCR” for specifying whether to change the file format, and “link transmission (Yes, No)” indicating whether to apply link transmission.

When the “link transmission” is set to “Yes”, it further includes “link format (document storage link, file transmission link (select from file transmission link addresses))” for specifying the type of link format, “transmit thumbnail (Yes, No)” indicating whether to transmit a thumbnail image, and “gather files (Yes, No)” indicating whether to gather transmission files. When the “gather files” is set to “Yes”, at the time of e-mail transmission or file transmission, a predetermined coding and compression method is applied to the files to be transmitted, to compress all the files.

When the “specify transmission/storage form” is set to “Yes”, it further includes “file name (Yes, No)” indicating whether to subject the file name to form synthesis, “file date (Yes, No)” indicating whether to subject the file date to the form synthesis, and “personal name (Yes, No)” indicating whether to subject the personal name to the form synthesis.

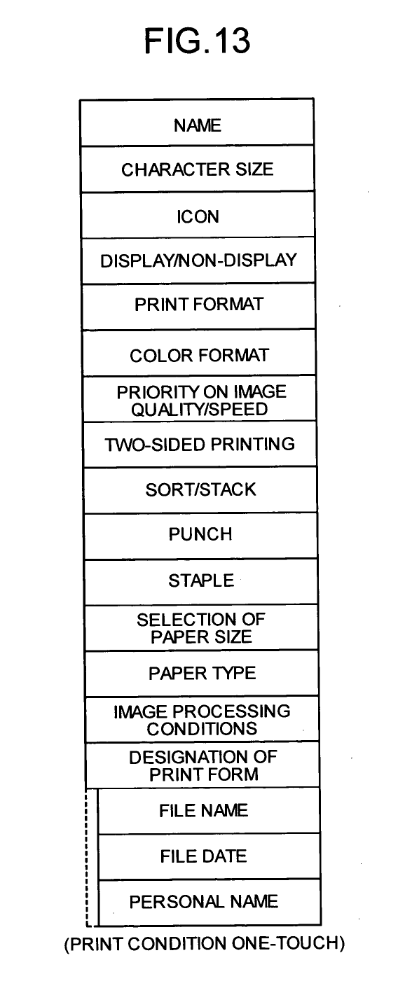

The print condition one-touch includes, for example as shown in FIG. 13, “name” for identifying the print condition on a one-touch button, “character size” for specifying the character size applied at the time of displaying the name on the one-touch button, “icon” for specifying an icon for displaying a simple image of the print condition on the one-touch button, “display/non-display” for specifying whether to display the print condition one-touch (when it is to be displayed, specification of the display mode is included), “print format (layout printing, repeat printing)” for specifying the print format, “color format (full color, monochrome, two colors (black/magenta, black/cyan)” for specifying the color format, “give priority to image quality/speed (give priority to image quality, or to speed)” for specifying whether to give priority to image quality or speed at the time of printing, “two-sided printing (Yes (open horizontally, open vertically), No)” for specifying whether to perform two-sided printing, “sort/stack” for specifying the sortation processing after printing, “punch (Yes (two on the left, two on the top, two on the right), No)” for specifying punching after printing, “staple (Yes (upper left, upper right, center (bind in the middle), two on the left, two on the top, two on the right), No)” for specifying stapling after printing, “select paper size (automatic paper size selection, select from selectable paper sizes)” for specifying the printing paper, “image processing conditions” for specifying the image processing condition at the time of printing, and “specify print form (Yes (select from form data), No)” for specifying the printing form.

When the “specify printing form” is set to “Yes”, it further includes “file name (Yes, No)” indicating whether to subject the file name to the form synthesis, “file date (Yes, No)” indicating whether to subject the file date to the form synthesis, and “personal name (Yes, No)” indicating whether to subject the personal name to the form synthesis.

When the “printing form” is “repeat printing”, the same image is used for the insert image to the form. For the “punch”, “Yes” cannot be selected when a finisher is not installed, and the number of punch depends on the finisher. For the “staple”, it is effective only when the number of sheets is two or more, and it cannot be selected when the finisher is not installed, and “bind in the middle” depends on the finisher. For the “select paper size”, the paper size under selection is registered to the one-touch button on a printing detail setting screen.

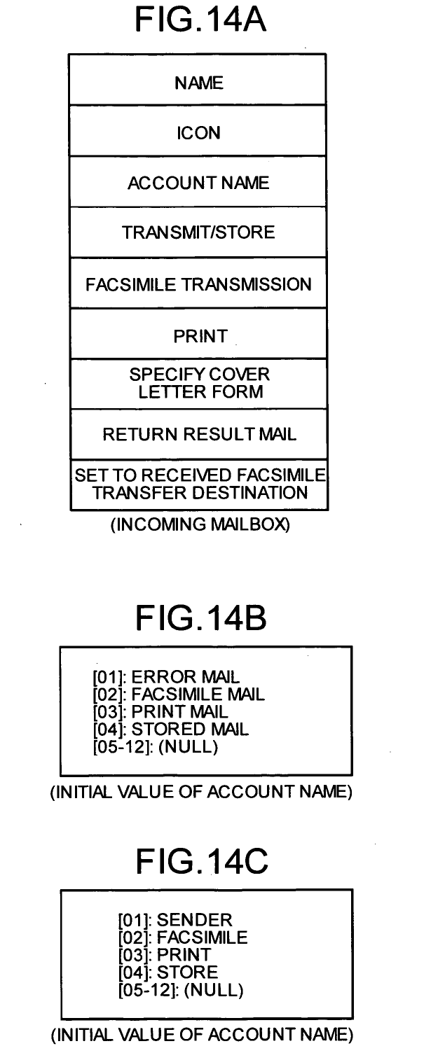

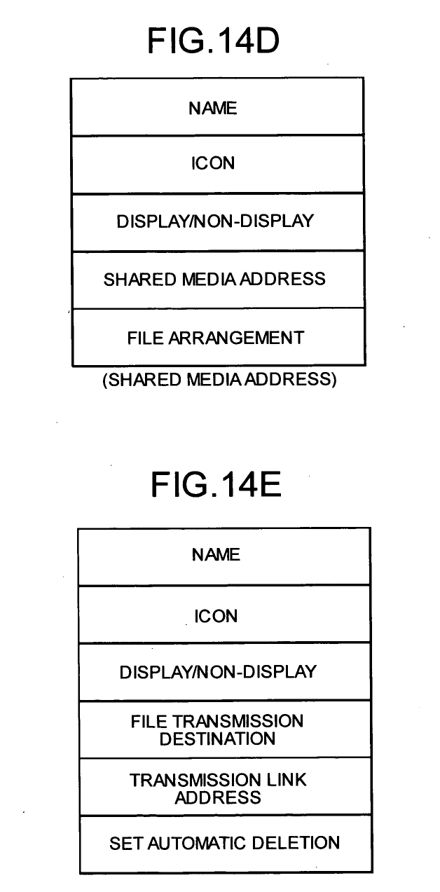

The incoming mailbox includes, for example as shown in FIG. 14A, “name” for identifying the incoming mailbox, “icon” for specifying an icon for displaying a simple image of the incoming mailbox, “account name” for registering an account name for using the incoming mailbox, “transmit/store” in which “Yes” is set only for a storage mailbox (described later), “facsimile transmission” in which “Yes” is set only for a facsimile mailbox (described later), “print” in which “Yes” is set only for a print mailbox (described later), “specify cover letter form (Yes, No)” in which “No” is fixedly set for an error mailbox (described later), and “Yes” is set for the facsimile mailbox and the print mailbox, and a selected value is set for other mailboxes, “return result e-mail (Yes, No)” in which “No” is fixedly set for an error mailbox (described later), and a selected value is set for other mailboxes, and “set to received facsimile transfer destination” in which “Yes” is set only for stored mailbox, and “No” is set for other mailboxes.

As to the “name”, as shown in FIG. 14B, an error e-mail (error mailbox for receiving an error e-mail such as a delivery error notification of an e-mail), a facsimile e-mail (facsimile mailbox: received e-mails in this mailbox are handled as facsimile transfer e-mails), a print e-mail (print mailbox: received e-mails in this mailbox are handled as printing e-mails, that is, the content of the received e-mail (including attached files) is printed out), and stored e-mail (storage mailbox: received e-mails in this mailbox are handled as stored e-mails, that is, the content of the received e-mail (including attached files) is stored) are respectively set in the incoming mailboxes [01] to [04] by system default. As for the remaining incoming mailboxes of from [05] to [12], the system default value is “null”, and a user can optionally set.

For the “account name”, as shown in FIG. 14C, “sender”, “facsimile”, “print”, and “store” are respectively set in the incoming mailboxes [01] to [04] by system default, so that the functions of the incoming mailboxes are made clear. As for the remaining incoming mailboxes of from [05] to [12], the system default value is “null”, and a user can optionally set.

For the “account name”, a unique character string is required for each incoming mailbox for each personal setting. The e-mail address becomes “display name”<account name=parameter.user ID@identification name.host name.domain name>. For the parameter, telephone number is the parameter for facsimile transmission, number of prints (when omitted, it means one print) for the print, and in the file transmission, no parameter is used. An actually usable SMTP/POP reception e-mail address is written on a set/store screen button.

For the “transmit/store”, transmission/storage form can be specified by transmission/storage condition one-touch, and storage in this case becomes storage in the “general document”. A private document name is stored in the “received e-mail” at all times without subject and password.

For the “facsimile transmission”, the facsimile address taken out from a parameter of to e-mail address is automatically added to the e-mail address in the specified transmission/storage condition preset.

For the “print”, the print format can be specified by using the print condition one-touch button.

The “specify cover letter form” is selected from forms that can be insetted in the e-mail header and the e-mail text. When “Yes” is selected, the form is applied only to the e-mail header/text. When “No” is selected, the form is adapted to the text file format in the standard setting. The text file attached to the e-mail is always adapted to the standard setting.

The “return result mail” is a setting whether to return an e-mail of the output result. In the embodiment, since the output image can be read on the website, there is no attached file at all times.

In the “set to received facsimile transfer destination”, only one in 12 incoming mailboxes can be set to “Yes”, and an image is transferred to a user set at the time of receiving the facsimile.

The shared media address includes, for example as shown in FIG. 14D, “name” for identifying the shared media address, “icon” for specifying an icon for displaying a simple image of the shared media address, “display/non-display” for specifying whether to display the shared media address (when it is to be displayed, specification of the display mode is included), “shared media address” in which an address selected from the “file address” in the registration information is stored, and “file arrangement order (not selected, ascending order of names, descending order of names, ascending order of dates, descending order of dates, ascending order of sizes, descending order of sizes)” for regulating the arrangement of files at the time of display.

When the “file arrangement order” is “not selected”, the files are displayed in a physical arrangement on the media side. For example, in the case of a digital camera, the arrangement is normally according to the order of taking photographs, and in the ascending order of file names. In the case of an external server, the arrangement is according to the agreement in the external server, and for example, in the descending order of updated date and time. In this case, a new file is displayed at the top.

The file transmission link address includes, for example as shown in FIG. 14E, “name” for identifying the file transmission link address, “icon” for specifying an icon for displaying a simple image of the file transmission link address, “display/non-display” for specifying whether to display the file transmission link address (when it is to be displayed, specification of the display mode is included), “file transmission destination” for specifying the transmission destination address of the file (an address at the time of upload), “transmission link address” for specifying the link address to be specified at the time of obtaining the transmitted file by another user, and “set automatic deletion (Yes (storage period: from one day to 180 days), No)”.

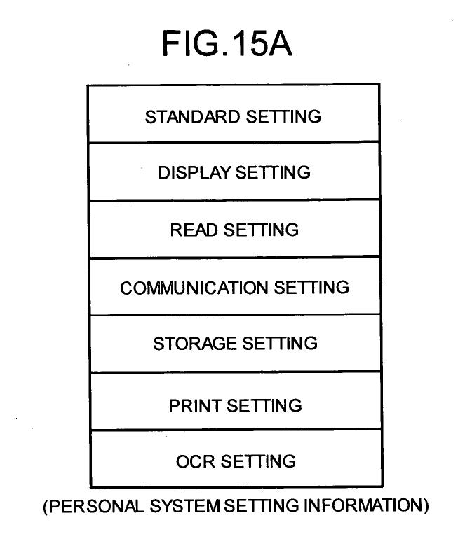

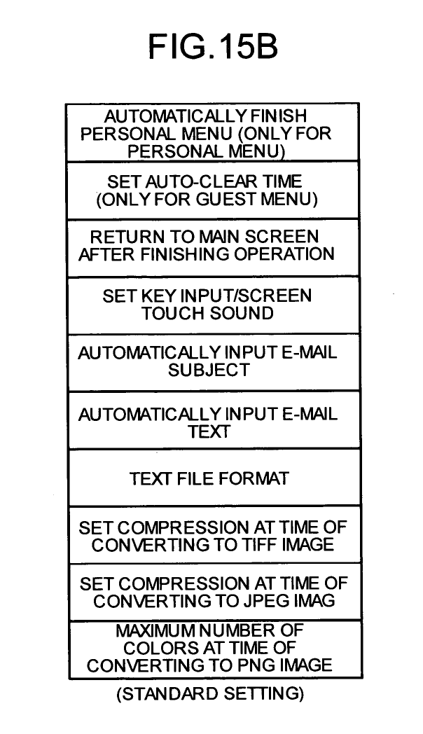

The personal system setting information includes seven categories, for example as shown in FIG. 15A, standard setting, display setting, read setting, communication setting, storage setting, print setting, and OCR setting.

The standard setting includes, for example as shown in FIG. 15B, “automatically finish personal menu (Yes (10 to 999 seconds), No)” for setting such that when no operation state continues, the personal menu is automatically closed (only for the personal setting information), “set auto-clear time (Yes (10 to 999 seconds), No)” for setting such that when the no operation state continues, an input value of the guest menu is automatically cleared (only for the guest setting information), “return to main screen after finishing operation (Yes, No)” for specifying whether to return to the main screen after finishing the operation by the user, “set key input/screen touch sound (Yes, No)” for specifying whether to allow the key input or screen touch sound to rumble, “automatically input e-mail subject (Yes (select from registered subjects), No)” for specifying whether to automatically input the e-mail subject at the time of sending an e-mail, “automatically input e-mail text (Yes (select from registered subjects), No)” for specifying whether to automatically input the e-mail text at the time of sending an e-mail, “set compression at the time of converting to Tag Image File Format (TIFF) image (no compression, modified Huffman (MH), modified read (MR), or modified modified read (MMR) method)” for specifying the compression method when the image data is converted to an image in the TIFF format, “set compression at the time of converting to joint photographic experts group (JPEG) image (any value from 9 levels) for specifying the image quality setting when the image data is converted to an image in the JPEG format, and “maximum number of colors at the time of converting to portable network graphics (PNG) image (2/4/8/16/32/64/128/256 colors) for specifying the maximum number of colors when the image data is converted to an image in the PNG format.

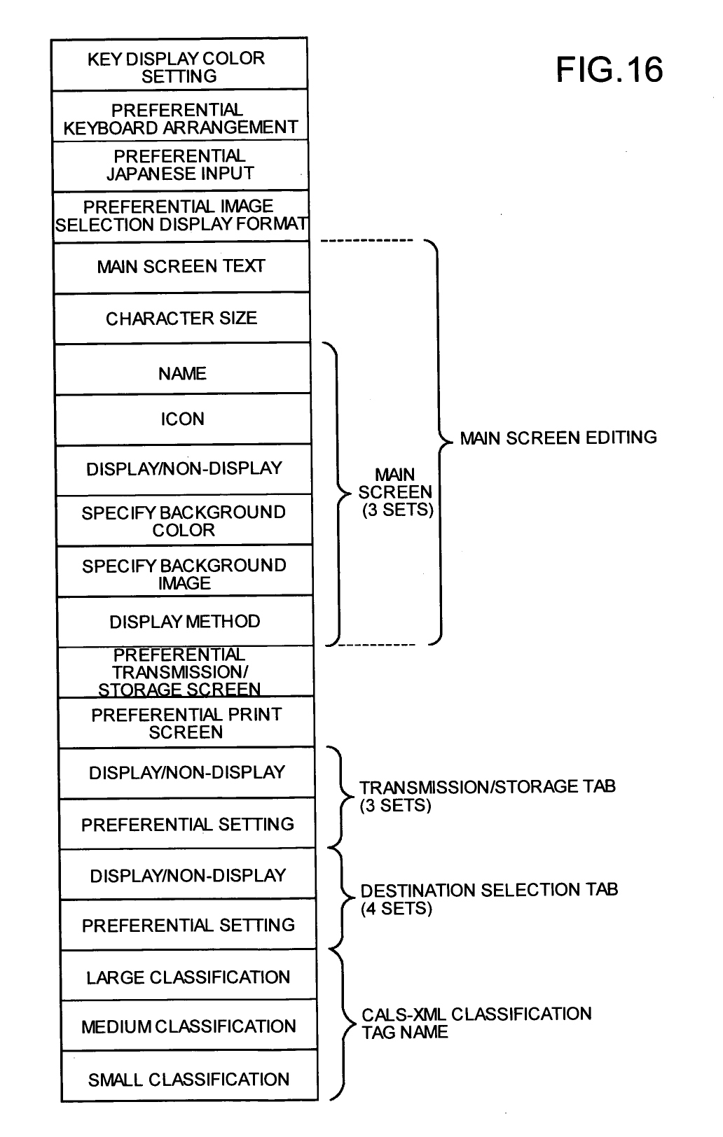

The display setting includes, for example as shown in FIG. 16, “key display color setting” for setting the display color of a keyboard to be displayed on a screen, “preferential keyboard arrangement (QWERTY type, ABC type)” for specifying the priority value in the key arrangement of the keyboard to be displayed on the screen, “preferential Japanese input (Roman character, Kana)” for specifying the priority value in the Japanese input method, “preferential image selection display method (thumbnail, list display)” for specifying the priority value in the display mode at the time of image selection, “main screen text” for specifying the type of text to be displayed on the main screen, “character size” for specifying the text size to be displayed on the main screen, “character size”, “name”, “icon”, “display/non-display (Yes (rearrange), No)”, “specify background color (Yes (select from Web safe color 216 colors), No)”, “specify background image (Yes (select image), No)”, and “display method (display in alignment, display in enlarged scale) for three main screens of “paper document”, “media document”, and “stored document”, “preferential transmission/storage screen (one-touch screen, detailed setting screen” for specifying a screen to be preferentially displayed on a transmission/storage screen, “preferential print screen (one-touch screen, detailed setting screen” for specifying a screen to be preferentially displayed on a print screen, “display/non-display (Yes (rearrangement), No)” and “preferential setting” for three transmission/storage tabs of “e-mail transmission”, “document storage”, and “file transmission”, “display/non-display (Yes (rearrangement), No)” and “preferential setting” for four address selection tabs of “e-mail address”, “facsimile address”, “group address”, and “public address book”, and “large classification”, “medium classification”, and “small classification” of CALS-XML classification tag name.

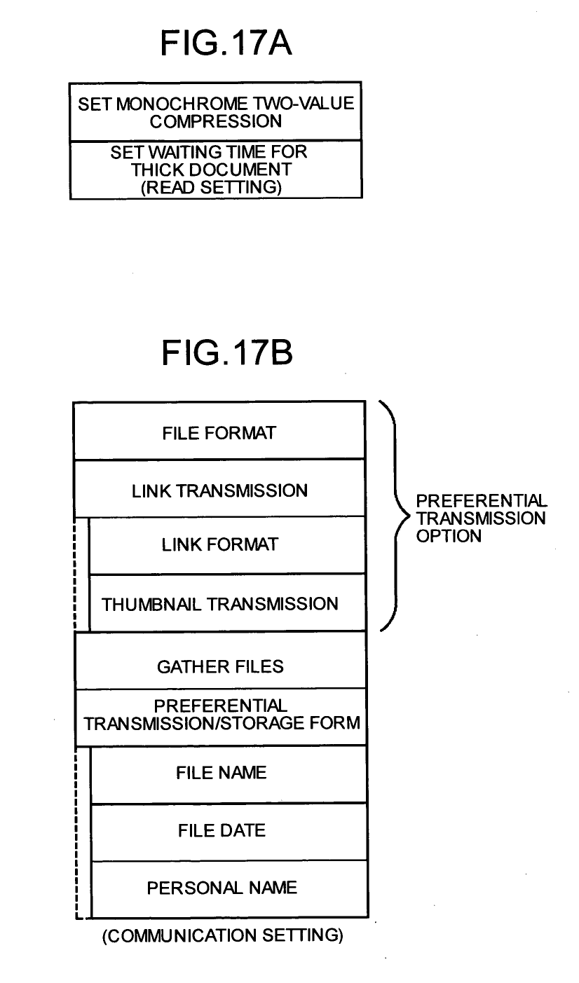

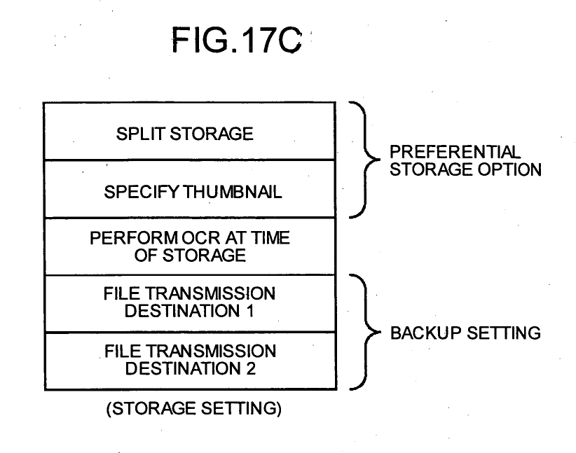

The read setting includes, for example as shown in FIG. 17A, “monochrome two value compression setting (no compression, MH, MR, or MMR method)” indicating setting for monochrome two value compression processing, and “set waiting time for thick document (Yes (60 to 999 seconds), No)” indicating the setting of waiting time for a thick document.

The communication setting includes, for example as shown in FIG. 17B, “file format (no change, image file, PDF, image PDF+OCR)” and “perform link transmission (Yes (described below), No)” (only effective for e-mail addresses) for preferential transmission options, “gather files (Yes, No)”, and “preferential transmission/storage form (default form)”.

When the “link transmission” is set to “Yes”, it further includes “link format (document storage link, file transmission link (select from file transmission link addresses)” and “thumbnail transmission” (thumbnail is transmitted in image PDF at all times. A wired transmission option is effective when the transmission format is not specified in the transmission/storage condition preset.

The “preferential transmission/storage form” is used when the transmission/storage form is not specified by the transmission/storage condition one-touch button, and “file name (Yes, No)”, “file date (Yes, No)”, and “personal name (Yes, No)” are included therein.

The storage setting includes, for example as shown in FIG. 17C, “split storage (Yes (number of pages for each split), No) and “designation of thumbnail (Yes (selection of page number and area), No)” as preferential storage options, “perform OCR at the time of storage (Yes, No)”, “file transmission destination 1 (primary transmission destination)” and “file transmission destination 2 (secondary transmission destination)” as backup setting for setting a place to be copied at the time of storage.

When the “perform OCR at the time of storage” is set to “Yes”, only general documents are subjected to OCR at the time of storing the document.

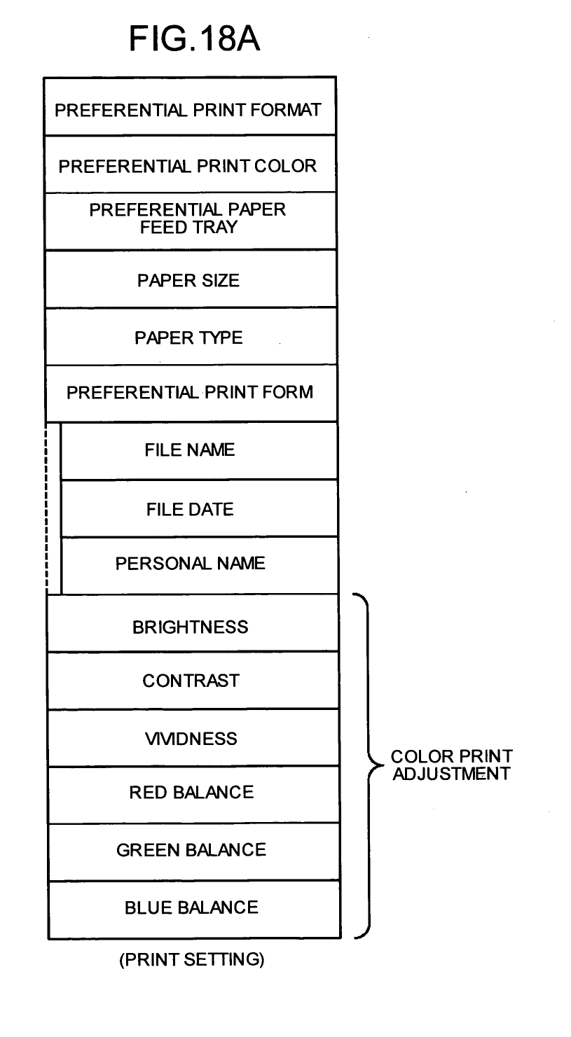

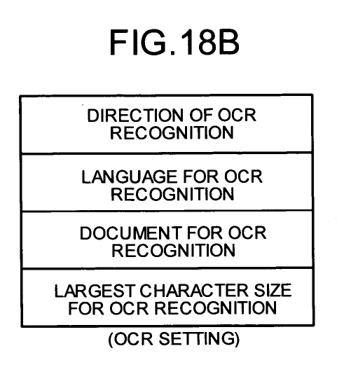

The print setting includes, for example as shown in FIGS. 18A and 18B, “preferential print format (layout printing, repeat printing)”, “preferential print color (full color, monochrome, black/cyan, black/magenta)”, “preferential paper feed tray (automatic sheet selection, tray 1, tray 2, tray 3, mass feed, manual feed (paper size, paper type))”, “paper size (when the “preferential paper feed tray” is “manual feed)”, “paper type” (when the “preferential paper feed tray” is “manual feed)”, “preferential print form (specific form)”, “brightness (−50% to +50%)”, “contrast (−50% to +50%)”, “vividness (−50% to +50%)”, “red balance (−50% to +50%)”, “green balance (−50% to +50%)”, and “blue balance (−50% to +50%)”, as color printing adjustment.

When form data is selected in the “preferential print form”, “file name (Yes, No)”, “file date (Yes, No)”, and “personal name (Yes, No)” are included therein.

The OCR setting includes, for example as shown in FIG. 18B, “direction of OCR recognition (automatic, horizontal writing, vertical writing, one column setting in horizontal writing, one column setting in vertical writing)”, “language for OCR recognition (automatic, Japanese, English)”, “document for OCR recognition (automatic, sentence, table)”, and “largest character size for OCR recognition (6 pt to 65 pt (point: the unit of character size)”.

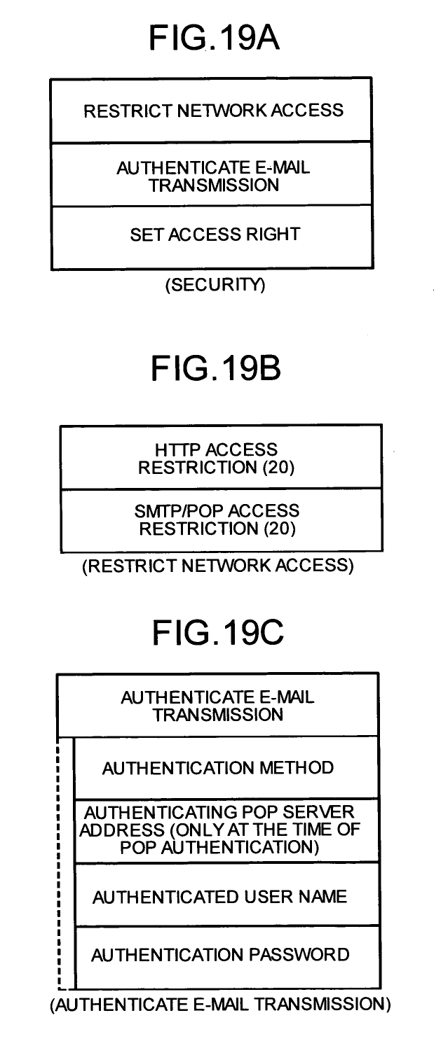

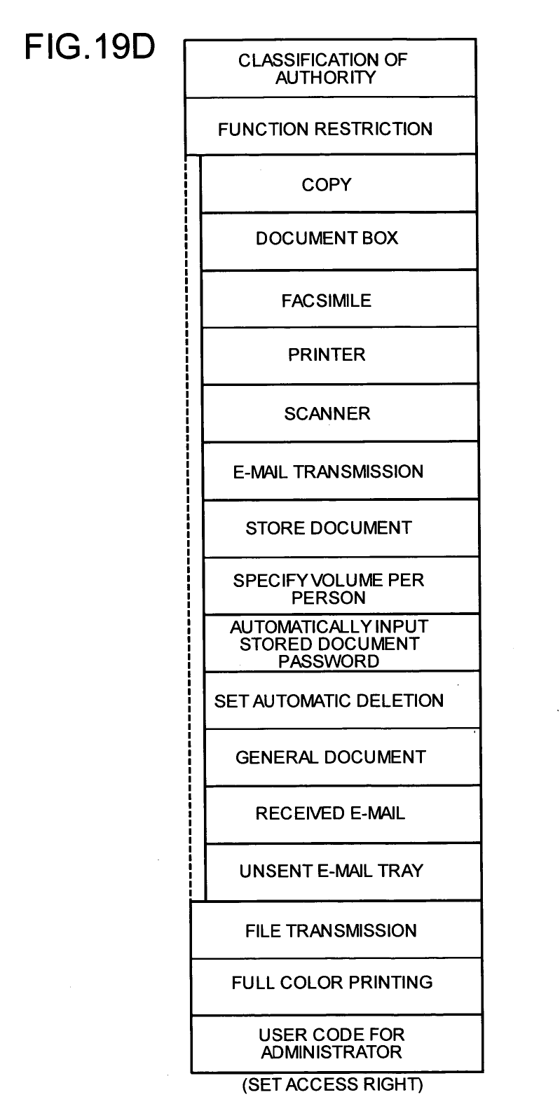

The security includes, for example as shown in FIG. 19A, restrict network access, authentication of e-mail transmission, and set access right.

The “restrict network access” includes, for example as shown in FIG. 19B, 20 “HTTP access restriction (Yes, setting of HTTP access restriction: IP address), No)”, and 20 “SMTP/POP access restriction (Yes, setting of SMTP/POP access restriction), No).

When the contents of the “HTTP access restriction” and the “SMTP/POP access restriction” are respectively “No”, administrator setting is applied to the “HTTP access restriction” and the “SMTP/POP access restriction”.

The “authentication of e-mail transmission” includes, for example as shown in FIG. 19C, “authentication of e-mail transmission (Yes, No) for specifying whether to set authentication information for each person, and when the “authentication of e-mail transmission” is set to “Yes”, “authentication method, (SMTP authentication, POP authentication)”, “authenticating server address (only at the time of POP authentication)”, “user name for authentication (user name at the time of SMTP/POP authentication)”, and “password for authentication (password at the time of SMTP/POP authentication)” are included therein.

The “set access right” includes, for example as shown in FIG. 19D, “classification of authority (administrator, general user)”, “function restriction (Yes, No)”, “file transmission (approve, disapprove)”, “full color print (approve, disapprove)”, and “user code for administrator”.

When the “function restriction” is set to “Yes”, “copy (approve, disapprove)”, “document box (approve, disapprove)”, “facsimile (approve, disapprove)”, “printer (approve, disapprove)”, “scanner (approve, disapprove)”, “e-mail transmission”, “store document”, and “set automatic deletion (approve, disapprove)”.

When the “document box” is set to “approve”, “specify volume per person (Yes (0.1 Gigabyte to 99.9 Gigabytes), No)” and “automatically input stored document password (Yes, No)” are included therein.

When the “set automatic deletion” is set to “approve”, “general document (Yes (storage period from one day to 180 days), No)”, “received e-mail (Yes (storage period from one day to 180 days), No)”, and “unsent e-mail tray (Yes (storage period from one day to 180 days), No)” are included therein.

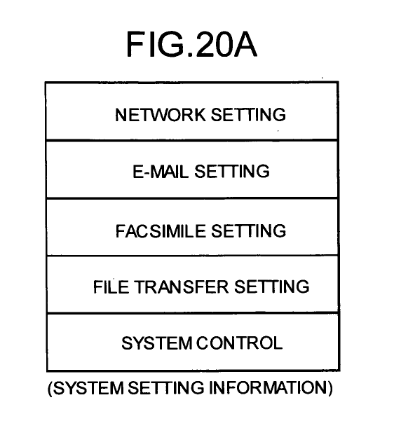

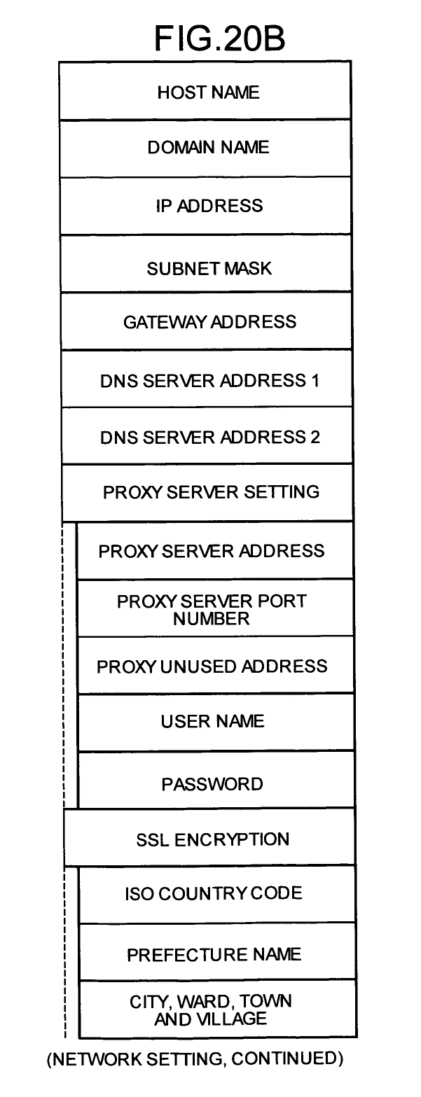

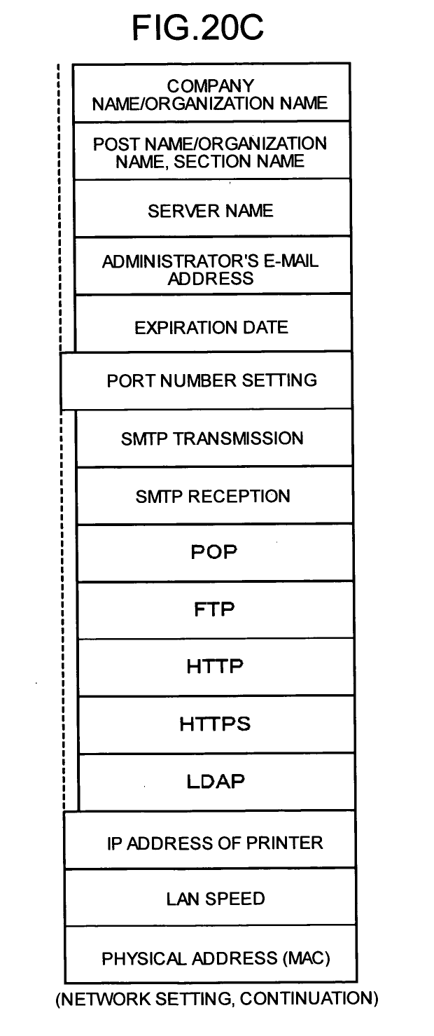

The system setting information includes five categories, for example as shown in FIG. 20A, network setting, e-mail setting, facsimile setting, file transfer setting, and system control.

The network setting includes, for example as shown in FIGS. 20B and 20C, “host name”, “domain name”, “IP address”, “subnet mask”, “gateway address”, “DNS server address 1 (IP address of a primary DNS server)”, “DNS server address 2 (IP address of a secondary DNS server)”, “proxy server setting (Yes, No)”. “SSL encryption (Yes, No)”, “port number setting (Yes, No)”, “IP address of printer”, “LAN (Ethernet) speed (automatic setting, 10 Megabits per seconds (Mbps) full duplex fixed, 100 Mbps full duplex fixed, 10 Mbps half duplex, 100 Mbps half duplex”, and “physical address (medium access control (MAC) address)”.

When the “proxy server setting” is set to “Yes”, “proxy server address”, “proxy server port number”, “proxy unused address”, “user name”, and “password” are included therein.

When the “SSL encryption” is set to “Yes”, “International Organization for Standardization (ISO) country code”, “prefecture name”, “city, ward, town, and village”, “company name/organization name”, “post name/organization name, section name”, “server name (initial value is “host name”)”, “administrator's e-mail address”, and “expiration date” are included therein.

When the “port number setting” is set to “Yes”, “SMTP transmission (initial value is 25)”, “SMTP reception (initial value is 25: 0 to 65535”, “POP (initial value is 110: 0 to 65535)”, “FTP (initial value is 21: 0 to 65535)”, “HTTP (initial value is 80: 0 to 65535)”, “hypertext transfer protocol security (HTTPS) (initial value is 443: 0 to 65535)”, and “LDAP (initial value is 389: 0 to 65535)” are included therein.

When the port number of the “SMTP transmission” is set to “0”, the SMTP transmission function cannot be used.

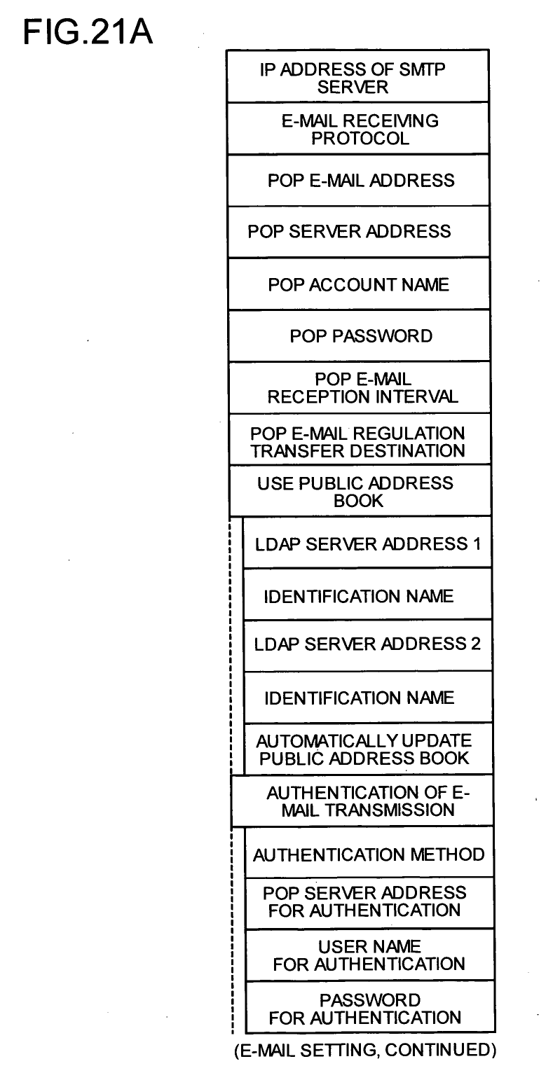

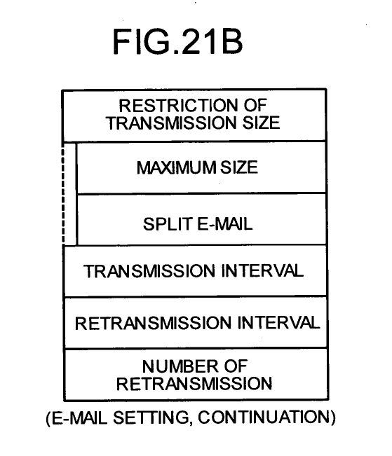

E-mail setting includes, for example as shown in FIGS. 21A and 21B, “IP address of SMTP server”, “e-mail receiving protocol (SMTP, POP3, APOP)”, “POP e-mail address”, “POP server address”, “POP account name”, “POP password”, “POP e-mail reception interval”, “POP e-mail regulation transfer destination (received e-mail address of the guest setting information)”, “use public address book (Yes, No)”, “authentication of e-mail transmission (Yes, No)”, “restrict transmission size (Yes, No)”, “transmission interval (0 to 99 seconds)”, “retransmission interval (1 to 99 minutes)”, and “number of retransmission (0 to 99 times)”.

When the “use public address book” is set to “Yes”, “LDAP server address 1”, “identification name”, “LDAP server address 2”, “identification name”, and “automatically update public address book (Yes (in the unit of 10 minutes), No)” are included therein.

When the “authentication of e-mail transmission” is set to “Yes”, “authentication method (SMTP authentication, pop authentication)”, “authenticating POP server address”, “user name for authentication”, and “password for authentication” are included therein.

When the “restrict transmission size” is set to “Yes”, “maximum size (1 to 20 MB)” and “split e-mail (Yes (number of splits: 2 to 99), No)” are included therein.

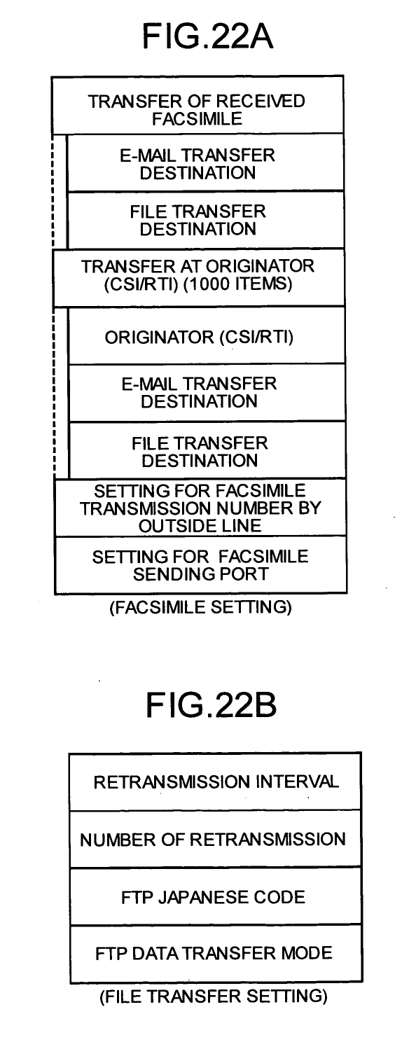

The facsimile setting is applied to function setting of transfer allocation (mail/file transmission destination) at the time of reception. For example, the facsimile setting includes, as shown in FIG. 22A, “transfer received facsimile (Yes, No)”, and “transfer at originator (CSI/RTI) (Yes, No)” for 1000 items, “set facsimile transmission number by outside line”, and “set facsimile sending port”.

The content of the “transfer at originator (CSI/RTI)” for one item includes “originator (CSI/RTI)”, “e-mail transfer destination (select from “e-mail/group address” and “registered users” in the guest setting information)”, and “file transfer destination (select from “file address” in the guest setting)”.

Up to 100 items can be registered in the “e-mail transfer destination”, and up to 4 items can be registered in the “file transfer destination”.

The file transfer setting includes, as shown in FIG. 22B, “retransmission interval (60 to 999 seconds)”, “number of retransmission (0 to 999 times), “FTP Japanese code (shift JIS, EUC)”, and “FTP data transfer mode (PORT mode, PASV mode)”.

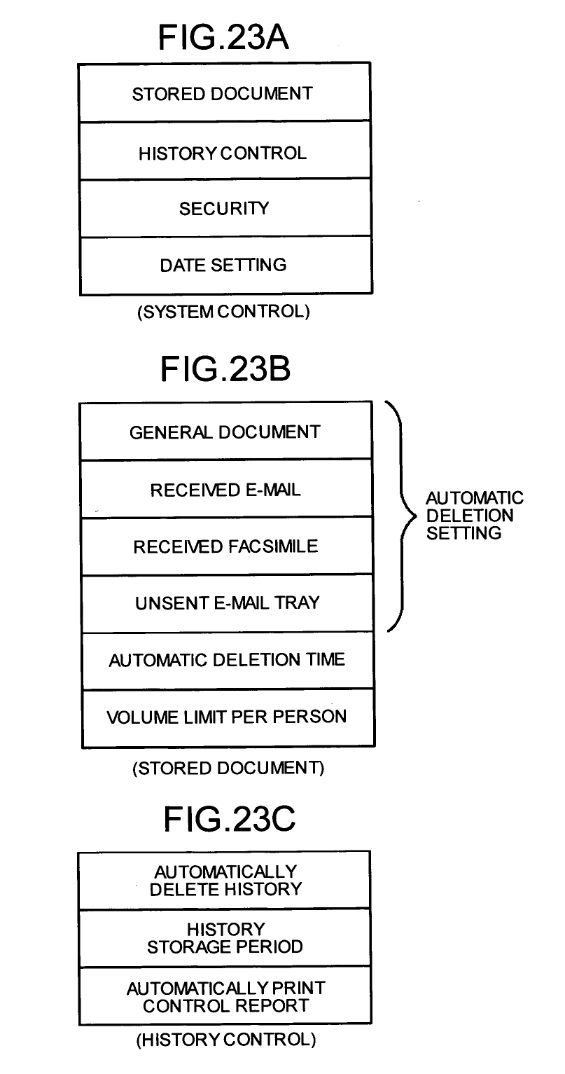

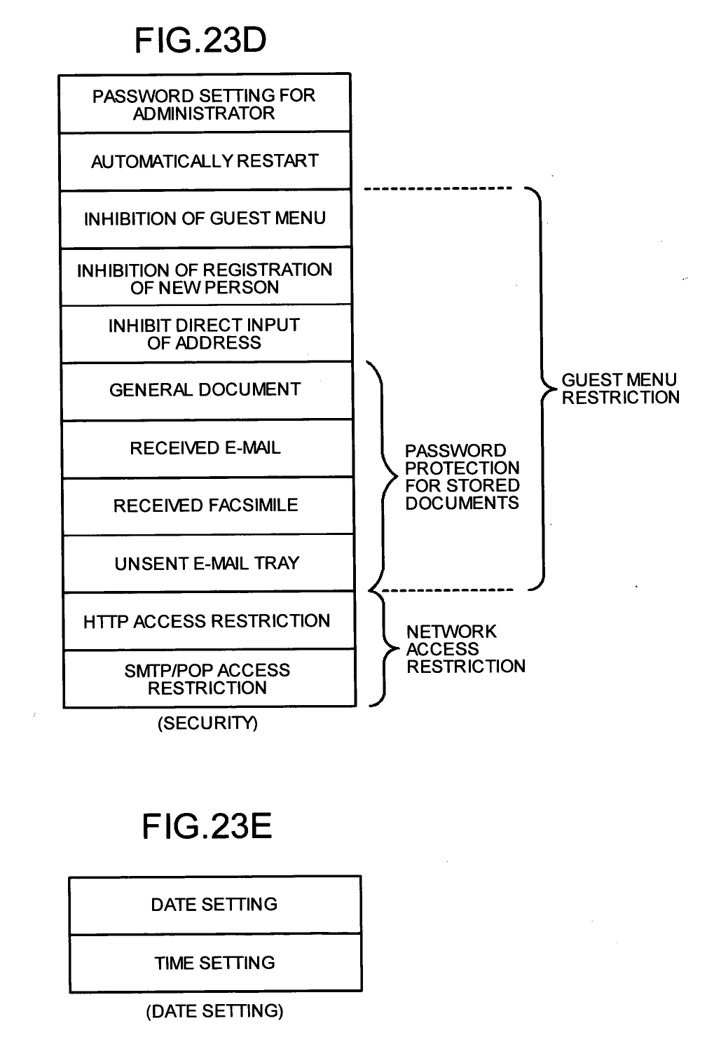

The system control includes four categories, for example as shown in FIG. 23A, stored document, history control, security, and date setting.

The stored document includes, for example as shown in FIG. 23B, “general document (Yes (storage period from one day to 180 days), No)”, “received e-mail (Yes (storage period from one day to 180 days), No)”, “received facsimile (Yes (storage period from one day to 180 days), No)”, and “unsent e-mail tray (Yes (storage period from one day to 180 days), No)” relating to automatic deletion setting, “automatic deletion time (deletion time 0:00 to 23:50), and “volume limit per person (Yes (0.1 Gigabyte to 99.9 Gigabytes), No)”.

The history control includes, for example as shown in FIG. 23C, “automatically delete history (Yes (deletion time 0:00 to 23:50), No)”, “history storage period (one day to 180 days)”, and “automatically print control report (Yes (print time 0:00 to 23:50), No)”.

The security includes, for example as shown in FIG. 23D, “password set for administrator”, “automatically restart (Yes (restart time 0:00 to 23:50), No)”, and “inhibit guest menu (Yes, No)”, “inhibit registration of new person (Yes, No)” and “inhibit direct input of address (Yes, No)” relating to the guest menu restriction, “general document (Yes, No)”, “received e-mail (Yes, No)”, “received facsimile (Yes, No)”, and “unsent e-mail tray (Yes, No)” relating to password protection for stored documents of the guests, and “HTTP access restriction (Yes (setting of HTTP access restriction), No)” and “SMTP/POP access restriction (Yes (setting of SMTP/POP access restriction), No)” relating to the network access restriction.

The password protection for stored documents of the guests is set such that when a user accesses the stored documents from the screen of the apparatus or from the Web browser, the user uses the password set for the administrator, and the user name in the Web browser is an identification name of the guest setting.

The date setting includes, for example as shown in FIG. 23E, “date setting (current time: 2003 to 2099, January to December, 1 to 31st”, and “time setting (current time: 0 to 23 (hour), 0 to 59 (minutes), and 0 to 59 (seconds)”.

In the case of communication requiring authentication, and for example, when the other party is a person using the same type of machine as the digital color multifunction product 1, if the URL for obtaining a file is informed as the link information by an e-mail, the digital color multifunction product 1 may not be able to log-on to the FTP server (file server) at the time of obtaining the file, and hence, acquisition of the file may fail.

To avoid such a situation, the link information to be informed by the e-mail may include the user ID and the password at the time of log-on to the target FTP server, but since the e-mail is transmitted not in the encrypted state, it is not desirable in view of the security.

In the embodiment, therefore, a confidential link is introduced so as to cope with such a situation.

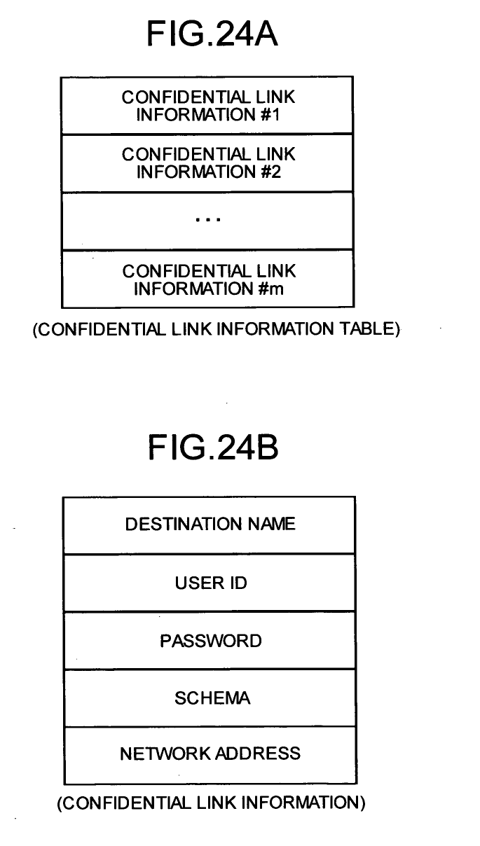

In other words, the digital color multifunction product 1 includes a confidential link information table in which a plurality of confidential link information as shown in FIG. 24A is stored. Each confidential link information includes, as shown in FIG. 24B, “destination name”, “user ID”, “password”, “schema”, and “network address”.

Normally, devices frequently transferring the confidential link have common confidential link information, and a sender side adds, for example, “network address/file name” to the text information of the e-mail to be transmitted, to specify the confidential link information to be used.

In this case, a receiver side of the e-mail searches the confidential link information table by using the “network address” included in the received e-mail as a key, to extract the intended confidential link information.

The receiver side uses the “schema” and the “network address” registered in the confidential link information, to access the FTP server (file server) to obtain the intended file. When authentication is required from the FTP server, the receiver side uses the user ID and the password for the authentication.

After log-in to the FTP server, the receiver side searches the intended “file name”, and obtains the file extracted by the search from the FTP server.

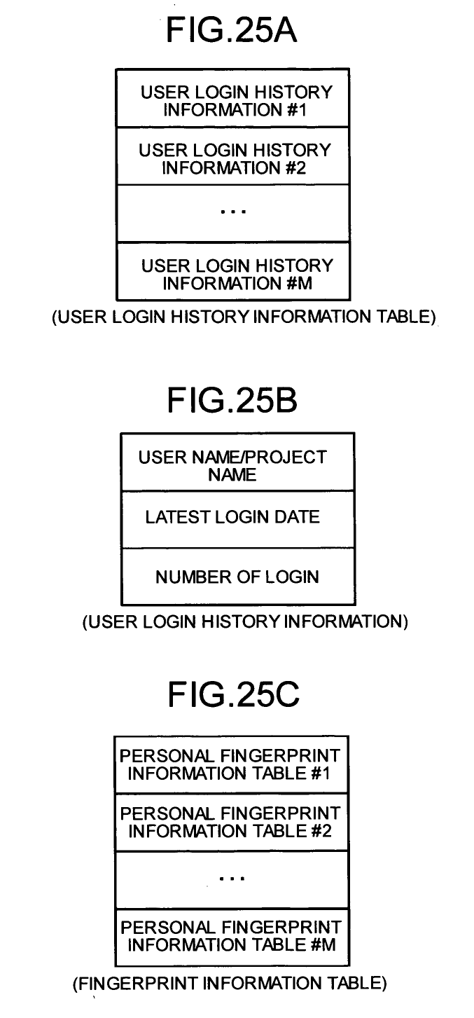

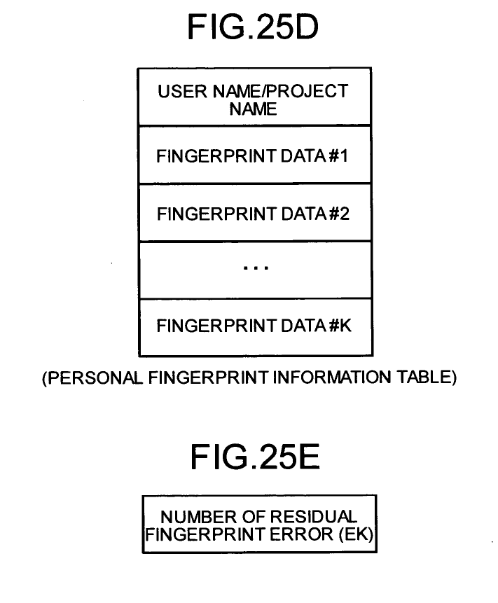

In the embodiment, a user login history information table as shown in FIG. 25A is stored, in order to store the login histories of respective users. The user login history information stored in the user login history information table includes, as shown in FIG. 25B, user name (including a project name (described later)) of the user, the latest date when the user logged in, and number of login.

In the embodiment, for fingerprint authentication, a fingerprint information table including m (for example, m=100) personal fingerprint information tables as shown in FIG. 25C is stored. The respective personal fingerprint information tables include, as shown in FIG. 25D, user name/project name expressing a user name or a project name, and fingerprint data including one to ten fingerprint data.

As the fingerprint data, the content of the fingerprint information output from the fingerprint sensor FS is directly stored. For the fingerprint data, when the personal fingerprint information table is for an individual user, fingerprints of one to ten fingers registered by the user are respectively registered. When the personal fingerprint information table is for one project, fingerprint data for one to ten fingers registered by one to ten users belonging to the project are registered.

In the embodiment, since the capacitance type fingerprint sensor is used for the fingerprint sensor FS, residual fingerprints due to sweat from sweat glands adhered on the sensor surface may be detected, and hence, the fingerprint sensor FS may detect an error. The error detection by the fingerprint sensor FS due to the residual fingerprints is normally dissolved after one or two continuous error detections.

On the other hand, error detection output from the fingerprint sensor FS may occur due to various reasons, not only due to the residual fingerprints, but also when a person touches the sensor surface of the fingerprint sensor FS (because cause is well known, the explanation thereof is omitted). The error detection by the fingerprint sensor FS in this case occurs continuously unless the cause of the error detection is removed.

Therefore, it is necessary to determine whether the error detection output from the fingerprint sensor FS is due to the residual fingerprints, or due to other events. In the embodiment, therefore, as shown in FIG. 25E, the number of residual fingerprint errors EK is set and stored, to determine whether the cause of error detection by the fingerprint sensor FS is due to the residual fingerprints, or due to other events.

In the embodiment, based on the above configuration, when a user touches the sensor surface of the fingerprint sensor FS, and the fingerprint information is detected by the fingerprint sensor FS, the authentication processing is immediately started. When the user is authenticated by the fingerprint authentication, the personal menu of the user is displayed, so that the registered user can use the digital color multifunction product 1.

Accordingly, the user can use the digital color multifunction product 1 without inputting the user ID and the password, which is very convenient.

When the fingerprint authentication is to be performed, normally, total number of fingerprint data registered in the respective personal fingerprint information tables and the fingerprint information obtained by the fingerprint sensor SF are sequentially inspected (total inspection) for the respective personal fingerprint information tables registered in the fingerprint information table. Hence, a long time may be necessary until the authentication processing finishes, depending on the user who logs in.

To avoid such a situation, in the embodiment, an authentication priority of the user is set based on the user login history information, and collation of the fingerprint data is performed from a user at a higher rank in the authentication priority.

The setting method of the authentication priority is, for example, such that a date ranking in which the latest login dates in the user login history information are arranged in order of the latest date, and a frequency ranking in which the login frequencies in the user login history information are arranged in order of from the most frequent to the least frequent are formed, and the authentication priority is determined based on the date ranking and the frequency ranking.

At this time, if weighting for the date ranking is set large, and weighting for the frequency ranking is set small, better results may be obtained. For example, the weighting order is calculated from (weighting ranking)=((date ranking)*KA+(frequency ranking)*KB) (where KA<KB), and the one having the smallest value in the weighting ranking is set to be the highest in the authentication priority.

By setting the authentication priority of the user in this manner, the logged in user can be specified in an earlier stage.

On the other hand, when the authentication processing is performed according to such authentication priority, a user who logged in a long time ago or a newly logged-in user will have to wait for a long time until the authentication processing finishes.

Therefore, for example, when three seconds or more have passed since the fingerprint authentication processing was started, the fingerprint authentication processing is discontinued, a login screen is displayed to request input of the user ID and the password, and the authentication processing is performed by using the input user ID and password.

Accordingly, an appropriate authentication method can be applied to both of frequent users and infrequent users, thereby improving the user-friendliness.

The time for discontinuing the fingerprint authentication processing may be longer than three seconds. Generally, however, it is said that when a user is kept waiting for three seconds or more, the user feels unfairly kept waiting. Therefore, it is desired to set the waiting time to about three seconds. If a wait message dialog or the like can be displayed to request the user to wait, the waiting time may be set to four seconds or more.

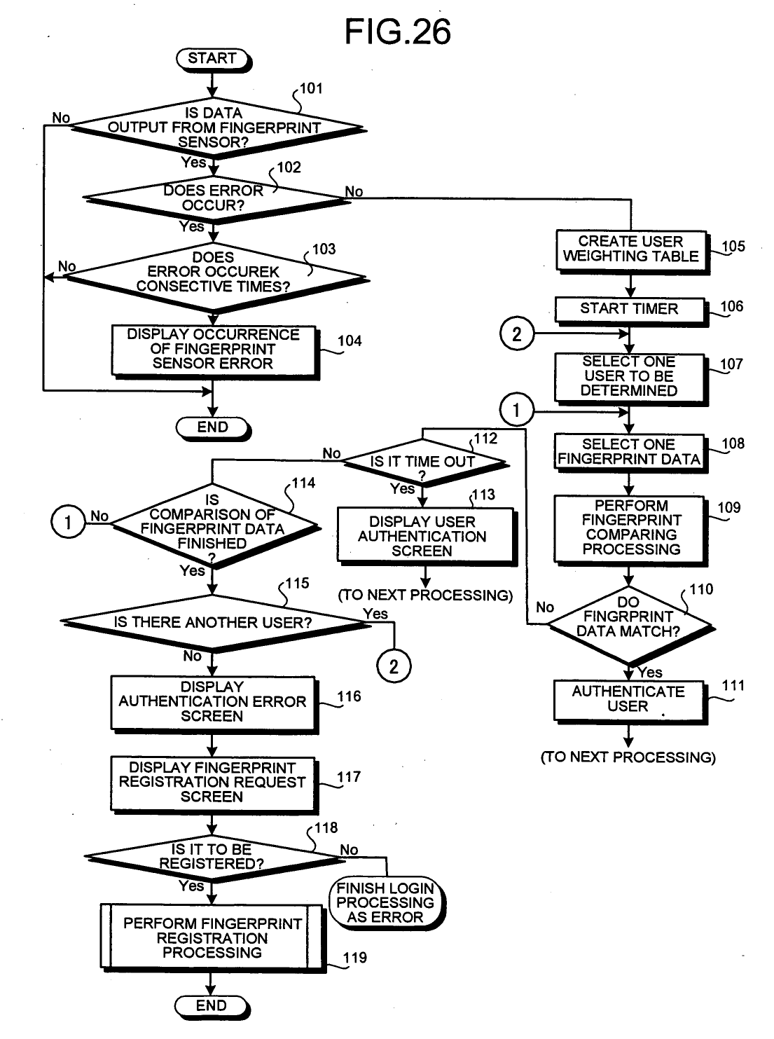

FIG. 26 is one example of user authentication processing according to the embodiment.

At first, it is monitored that the fingerprint sensor FS outputs data (“NO” loop at determination 101), and when data is output from the fingerprint sensor FS, and the result at determination 101 becomes “YES”, it is checked if there is an error detection (determination 102).

When the result at determination 102 becomes “YES”, it is checked if error detection continues more than the number of times determined in the number of residual fingerprint errors EK (determination 103), and when the result at determination 103 is “NO”, control returns to determination 101.

When the result at determination 103 is “YES”, it is displayed that an error has occurred in the fingerprint sensor FS (processing 104), and the processing is finished as an error.

On the other hand, when significant data is output from the fingerprint sensor FS, and the result at determination 102 is “NO”, the weighting ranking is calculated based on the content in the user login history information table, according to the above method, to create a user weighting table in which the weighting ranking is summarized (processing 105). In the user weighting table, the priority and the user name are combined in a set, and arranged in an ascending order of the priority (in order of from smaller value to larger value). A timer for regulating the time for discontinuing the fingerprint authentication processing is then started (for example, time out after three seconds) (processing 106).

A user having the highest priority is selected according to the user weighting table (processing 107), one fingerprint data is selected from the personal fingerprint information table of the selected user to be determined (processing 108), and fingerprint collation processing is performed for collating the fingerprint data selected at processing 108 with the fingerprint information input from the fingerprint sensor FS (processing 109).

In the fingerprint collation processing, it is checked if these fingerprints agree with each other (determination 110), and when the result at determination 110 is “YES”, the user authentication result becomes “OK” (processing 111), to proceed to next processing. For example, a pre-registered personal menu is displayed, to perform the subsequent processing.

When the result at determination 110 is “NO”, it is checked if the timer started at processing 106 becomes time out (determination 112). When the result at determination 112 is “YES”, a user authentication screen is displayed, to request the user to input the user ID and the password (processing 113), to execute the subsequent processing.

When the result at determination 112 is “NO”, it is checked if collation for all fingerprint data in the personal fingerprint information table of the selected user has finished (determination 114), and when the result at determination 114 is “NO”, control returns to processing 108, to perform the collation operation for the next fingerprint data.

When the result at determination 114 is “YES”, it is checked if there is another user registered in the user weighting table (determination 115), and when the result at determination 115 is “YES”, control returns to processing 107 to select a user having the next highest priority registered in the user weighting table, and execute the subsequent processing repetitively.

When the result at determination 115 is “NO”, though collation of all fingerprint data has finished for all registered users, the user authentication has not finished, and hence, an authentication error screen is displayed (processing 116).

A fingerprint registration request screen is displayed for requesting (instructing) a new registration of fingerprint (processing 117), it is checked whether to specify that a user registers fingerprints with respect to the fingerprint registration request screen (determination 118), and when the result of determination 118 is “YES”, predetermined fingerprint registration processing is executed (processing 119), to finish the operation.

When it is specified that the user does not register fingerprints with respect to the fingerprint registration request screen, and the result at determination 118 is “NO”, the login processing is finished as an error.

As the type of the fingerprint sensor FS, not only the capacitance type fingerprint sensor (capacitance type semiconductor sensor) in the embodiment, but also other types of sensor can be used. For example, an optical sensor, a surface enhanced irregular reflection optical method, or a pressure-sensitive sensor may be used.

According to the present invention, the time required for authentication using fingerprints can be reduced, and user-friendliness can be greatly improved.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An authentication method for authenticating users, comprising:
storing first fingerprint information of the users, wherein the first fingerprint information includes fingerprint information of at least one finger of each of the users;
storing login information of each of the users;
setting a priority for each of the users based on the login information when second fingerprint information is input by the users to login; and
authenticating the users by comparing the first fingerprint information and the second fingerprint information, wherein
the authenticating includes authenticating the users in order based on the priority, from a user having a highest priority.

2. The authentication method according to claim 1, wherein
the storing login information includes storing information that includes a login date and a frequency of login, and
the setting includes setting the priority based on a date ranking in which the users are ranked based on a latest login date from a recent date to an old date, and a frequency ranking in which the users are ranked based on the frequency from a highest frequency to a lowest frequency.

3. The authentication method according to claim 1, wherein the authenticating includes classifying the users into a plurality of groups, and comparing the first fingerprint information and the second fingerprint information per unit of the group.

4. The authentication method according to claim 1, further comprising:
storing an identification number and a password for each user;
displaying an authentication screen for requesting a user to input an identification number and a password; and
authenticating the user by comparing the identification numbers and the passwords stored and the identification number and the password input, wherein
the displaying includes displaying the authentication screen when authentication of the users by comparing the first fingerprint information and the second fingerprint information is not completed within a predetermined time.

5. An apparatus for authentication of users, comprising:
a fingerprint sensor for inputting first fingerprint information of the users, wherein the first fingerprint information includes fingerprint information of at least one finger of each of the users;
a first memory that stores the first fingerprint information; and
a second memory that stores login information of each of the users, wherein
when second fingerprint information is input by the users via the fingerprint sensor to login, a priority for each of the users are set based on the login information, and
authentication of the users is carried out by comparing the first fingerprint information and the second fingerprint information in order based on the priority, from a user having a highest priority.

6. The apparatus according to claim 5, wherein
the login information includes a login date and a frequency of login, and
the priority is set based on a date ranking in which the users are ranked based on a latest login date from a recent date to an old date, and a frequency ranking in which the users are ranked based on the frequency from a highest frequency to a lowest frequency.

7. The apparatus according to claim 5, wherein the users are classified into a plurality of groups, and the authentication is carried out per unit of the group.

8. The apparatus according to claim 5, further comprising:
a third memory for storing an identification number and a password for each user; and
a display unit that displays an authentication screen for requesting a user to input an identification number and a password, wherein
the display unit displays the authentication screen when authentication of the users by comparing the first fingerprint information and the second fingerprint information is not completed within a predetermined time, and
authentication of the users is carried out by comparing the identification numbers and the passwords stored and the identification number and the password input.
